(19) United States
(12) Patent Application Publication
(10) Pub. No.: US 2013/0176659 A1
(43) Pub. Date: Jul. 11, 2013

(54) ELECTRIC DOUBLE-LAYER CAPACITOR

(71) Applicant: National Institute of Advanced Industrial Science and Technology, Tokyo (JP)

(72) Inventors: Kenji HATA, Tsukuba-shi (JP); Ali IZADI-NAJAFABADI, Tsukuba-shi (JP)

(73) Assignee: National Institute of Advanced Industrial Science and Technology, Chiyoda-ku, Tokyo (JP)

(21) Appl. No.: 13/687,222

(22) Filed: Nov. 28, 2012

Related U.S. Application Data
(63) Continuation of application No. PCT/JP2011/062183, filed on May 27, 2011.

(30) Foreign Application Priority Data
May 28, 2010 (JP) 2010-123182

(51) Int. Cl. H01G 11/04

(52) U.S. Cl. CPC H01G 11/04; B82Y 30/00
USPC 361/502; 977/742

(57) ABSTRACT

An electric double-layer capacitor comprises a first polarizing electrode and a second polarizing electrode including a carbon nanotube aggregate formed by aggregating a plurality of carbon nanotubes and an electrolyte solution being immersed between the plurality of carbon nanotubes, the first polarizing electrode and the second polarizing electrode are provided with a conductivity of 0.5 S/cm; an electrode partially connected to the first polarizing electrode and the second polarizing electrode; and a separator arranged between the first polarizing electrode and the second polarizing electrodes; wherein the carbon nanotube aggregate has a relative surface area of 800 m²/g or more and 2,600 m²/g or less, a density of 0.5 g/cm³ or more and 1.5 g/cm³ or less and a pore size distribution maximum of 1 nm or more and 10 nm or less.

### CROSS REFERENCE TO RELATED APPLICATIONS

This application is based upon and claims the benefit of priority from the prior Japanese Patent Application No. 2010-123182, filed on May 28, 2010 and PCT Application No. PCT/JP2011/062183, filed on May 27, 2011, the entire contents of which are incorporated herein by reference.

### FIELD

The present invention is related to an electric double-layer capacitor. In particular, the present invention is related to an electric double-layer capacitor comprised of carbon nanotubes and which works at a high voltage and a manufacturing method of the same.

### BACKGROUND

Electric double-layer capacitors are electrochemical energy storage systems that store energy directly and physically as charge, whereas batteries e.g. Li-ion cells store energy in chemical reactants capable of generating charge. Electric double-layer capacitors are formed by a cell having a structure in which a pair of opposing polarizing electrodes via an ion permeable separator are immersed in an electrolyte, a pair of current collectors for collecting and extracting a charge are arranged facing the entire surface of a side surface of the polarizing electrode and a barrier component is arranged so to seal the electrolyte. An electric double-layer capacitor is provided as a product in which a plurality of these cells is stacked.

The energy density of electric double-layer capacitors (less than 10 Wh/kg) is lower than batteries (more than 100 Wh/kg), however their power is significantly higher, they can be charged and discharged rapidly, and due to being difficult to degrade and long lifetime electric double-layer capacitors are expected to be used for various purposes.

However, while an activated carbon (referred to below as AC) having a large surface area is used as an electrode in conventional electric double-layer capacitors, a conductive bonding agent is necessary to mold an AC which is a powder into an electrode, and a voltage which can be applied is limited to 3V since impurities or functional groups in the surface of the AC promote degradation and the lifetime of the electrode is reduced under conditions where a voltage higher than this is applied which is a problem.

Adding carbon nanotubes (referred to below as CNT) to the AC as a conductive material has been proposed in order to improve the conductivity of a polarizing current, for example, reducing a resistance component is disclosed in Japanese Laid Open Patent 2007-200979 by adjusting the relative surface area of an AC or the size ratio between an AC and CNT.

In addition, improving capacitance characteristics by not using a resin component which is a binder when paper molding an AC and CNT is disclosed in Japanese Laid Open Patent 2009-246306.

However, conventional electric double-layer capacitors have not solved the problem of a voltage which can be applied is limited to 3V and the lifetime of the electrode is reduced under conditions where a voltage higher than this is applied. In addition, in conventional electric double-layer capacitors it is necessary to arrange a pair of current collectors facing the entire side surface of a pair of polarizing electrodes which sandwich a separator and these current collectors are generally formed from a metal. Since electric double-layer capacitors have a structure in which cells are stacked, a current collector affects the volume and weight of an electric double-layer capacitor and is a barrier to small scale and light weight of a an electric double-layer capacitor.

Because the present invention has a long lifetime, operates at a high voltage and does not require a current collector arranged on the entire side surface of a polarizing electrode, an electric double-layer capacitor is provided which can be easily reduced in size and weight.

### SUMMARY

According to one embodiment of the present invention an electric double-layer capacitor is provided comprising a first polarizing electrode and a second polarizing electrode including a carbon nanotube aggregate formed by aggregating a plurality of carbon nanotubes and an electrolyte solution being immersed between the plurality of carbon nanotubes, the first polarizing electrode and the second polarizing electrode are provided with a conductivity of 0.5 S/cm or more, an electrode connected to the first polarizing electrode and the second polarizing electrode, and, a separator arranged between the first polarizing electrode and the second polarizing electrodes, wherein the carbon nanotube aggregate has a relative surface area of 800 m²/g or more and 2,600 m²/g or less, a density of 0.5 g/cm³ or more and 1.5 g/cm³ or less and a pore size distribution maximum of 1 nm or more and 10 nm or less, and a charge flows through the first polarizing electrode and/or the second polarizing electrode in a horizontal direction and a perpendicular direction towards the electrode, and wherein the electric double-layer capacitor is driven at a high driving voltage of 3.5V or more and 4.5V or less, and possible number of times of charging and discharging is 1,000 or more.

In addition, according to one embodiment of the present invention, an electric double-layer capacitor is provided comprising a first polarizing electrode and a second polarizing electrode including a carbon nanotube aggregate formed by aggregating a plurality of carbon nanotubes, a separator arranged between the first polarizing electrode and the second polarizing electrodes, an electrode partially connected to the first polarizing electrode and/or the second polarizing electrode, and a barrier component covering the first polarizing electrode and the second polarizing electrode, wherein the first polarizing electrode and/or the second polarizing electrode are provided with a 1 mass % of metal impurities and the capacitor is driven with a driving voltage of 3.5V or more and 4.5V or less, and possible number of times of charging and discharging is 1,000 or more.

The carbon nanotube aggregate may have a relative surface area of 800 m²/g or more and 2,600 m²/g or less, a density of 0.5 g/cm³ or more and 1.5 g/cm³ or less and a pore size distribution maximum of 1 nm or more and 10 nm or less.

The electrode may be arranged on a side surface of the first polarizing electrode and the second polarizing electrode and the electrode may have a mesh shape.

The electrode may be arranged on a side surface of the first polarizing electrode and the second polarizing electrode and an external electrode terminal may be further arranged.

The electrode may be arranged on an end part of the first polarizing electrode and the second polarizing electrode.

### BRIEF DESCRIPTION OF THE DRAWINGS

FIG. 1 is a diagram of an electric double-layer capacitor 100 related to one embodiment of the present invention;

FIG. 2 is a diagram of an electric double-layer capacitor 200 related to one embodiment of the present invention;

FIG. 3 (a) is a flowchart of a manufacturing process S100 of an electric double-layer capacitor related to one embodiment of the present invention, and (b) is a diagram of this process;

FIG. 4 is a diagram of an electric double-layer capacitor 300 related to one embodiment of the present invention;

FIG. 5 is a diagram of an electric double-layer capacitor 400 related to one embodiment of the present invention;

FIG. 6 is a diagram of an electric double-layer capacitor 500 related to one embodiment of the present invention;

FIG. 7 is a diagram of an electric double-layer capacitor 600 related to one embodiment of the present invention;

FIG. 8 (a) is a SEM image observed from a side surface of a polarizing electrode 110 and (b) is a cyclic voltammogram; FIG. 9 (a) shows a 3V discharge profile and (b) shows a 4V discharge profile;

FIG. 10 is a diagram showing a capacitance density in a current density range of 1 A/g-50 A/g;

FIG. 11 (a) is a diagram showing an internal resistance of an electric double-layer capacitor and (b) is a diagram showing energy discharged from an electrode at various discharge powers;

FIG. 12 is a diagram showing the result of a stability test of an electrode when charging and discharging is performed;

FIG. 13 is a diagram showing a 1, 100, 1,000^{th} charging and discharging cycle of a durability test, (a) shows the result of the electric double-layer capacitor 200 in Example 1 and (b) shows the result of the electric double-layer capacitor 700 in Comparative Example 1;

FIG. 14 shows an impedance bode plot, (a) shows the amplitude and (b) shows the phase of the impedance;

FIG. 15 is a diagram showing a performance prediction of an electric double-layer capacitor related to the examples and

FIG. 16 (a) is a diagram showing a manufacturing process of an AC electrode 710 and (b) is a SEM image of the AC electrode 710.

### DESCRIPTION OF EMBODIMENTS

The electric double-layer capacitor and manufacturing method thereof related to the present invention is explained below while referring to the diagrams. The electric double-layer capacitor related to the present invention comprises an electrode which includes a carbon nanotube aggregate. The electric double-layer capacitor and manufacturing method thereof of the present invention should not be interpreted as being limited to details of the embodiments and the examples shown below. Furthermore, in the present embodiment and diagrams which are referred to in the examples described below, the same reference symbols are attached to those parts which are the same or have the same function and repeating explanations of these parts are omitted.

Here, the relationship between a voltage and performance in an electric double-layer capacitor is explained. Formula (1) shows the relationship between a voltage and energy and formula (2) shows the relationship between a voltage and maximum power density.

$$\begin{matrix}[ Formula 1 ] & \\ E = \frac{1}{2} {CV}^{2} & ( 1 ) \\ [ Formula 2 ] & \\ {P}_{max} = \frac{{V}^{2}}{4 {R}_{s}} & ( 2 )\end{matrix}$$

In formula (1) E indicates energy, C indicates capacity and V indicates a voltage. As can be seen in formula (1), a voltage affects energy by a power of 2. In formula (2), Pₘₐₓ indicates maximum power density and Rₛ indicates an internal resistance. As can be seen in formula (2), a voltage affects maximum power density by a power of 2. Therefore, if an operating voltage can be increased, the obtained result is a difference of a power of 2 over a conventional electric double-layer capacitor. If an electric double-layer capacitor which operates at a high voltage and has a long lifetime can be obtained, it is possible to output a high energy and high power density and to use the electric double-layer capacitor for a wide range of purposes instead of a conventional battery.

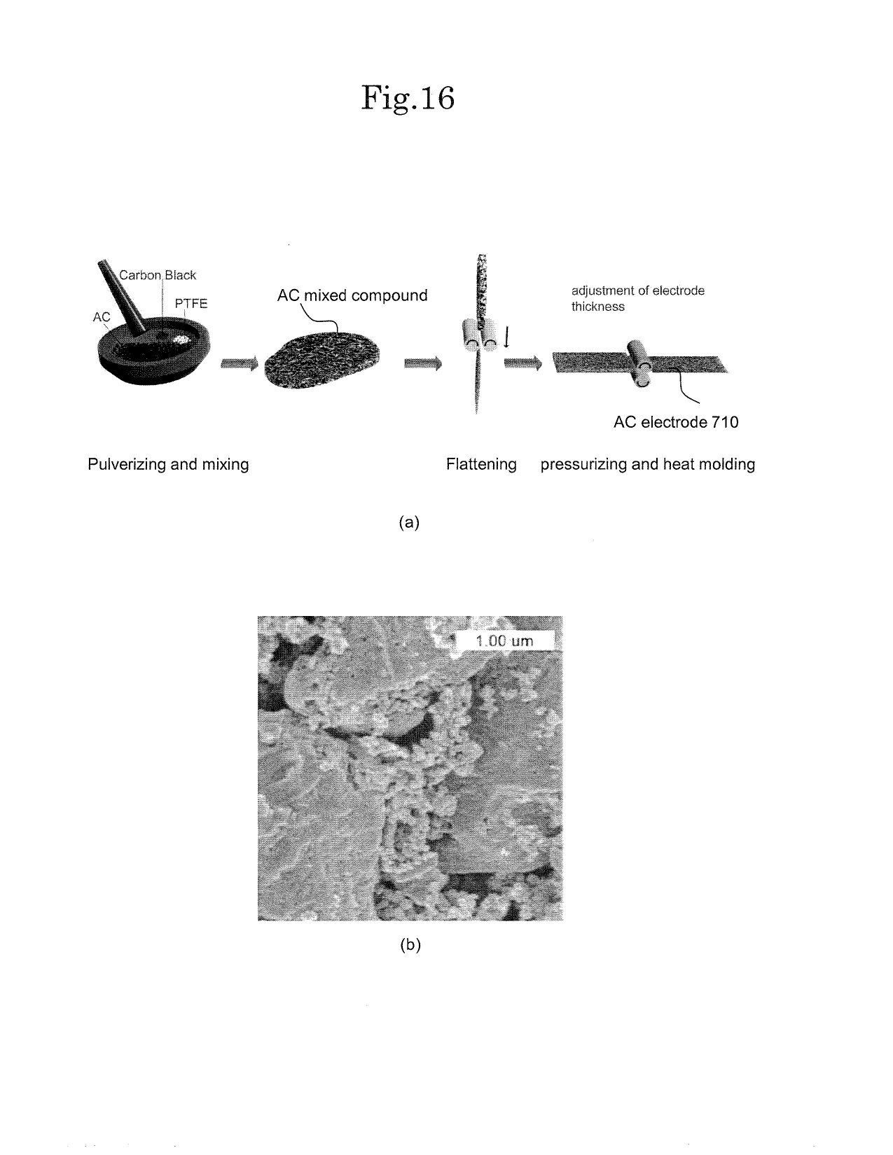

The inventors of the present invention eagerly examined the reasons why the conventional electric double-layer capacitor described above cannot operate stably over a long lifetime under high voltage conditions. A SEM image of a conventional AC electrode 710 is shown in FIG. 16 (b). The conventional AC electrode 710 is formed by arranging an AC and carbon black irregularly. The inventors of the present invention found that because there are many resistance components in an electrode of a conventional electric double-layer capacitor as before, a current collector is required and because chemical reactants or impurities exist, the electric double-layer capacitor cannot operate at a high voltage over a long lifetime. Therefore, forming an electrode using a material with few impurities and high conductivity and applying this electrode to the electric double-layer capacitor was examined.

The inventors of the present invention conducted research into a CNT structure having a high orientation using a Chemical Vapor Deposition method (referred to as CVD below), for example, they reported on a single-walled CNT structure and manufacturing method thereof in Science 306, 1362-1364 (2004) and International Published Patent WO2006/011655. In addition, they also reported on double-walled CNT (referred to as double-walled CNT below) structures and manufacturing method thereof in Nature Nanotechnology 1, 131-136 (2006) and Japanese Laid Open Patent 2007-145634.

The inventors of the present invention examined applying the CNT structure with a high orientation using CVD (referred to below a super growth method) to an electric double-layer capacitor and reported in Japanese Laid Open Patent 2007-81384 that they found that a CNT includes a component having metal characteristics (conductivity) and a component having semiconductor characteristics and when a component including these semiconductor characteristics is used as an electrode material of an electric double-layer capacitor, electrochemical doping (p-doping and n-doping) is produced and carrier density is increased when the CNT having semiconductor characteristics is polarized when contacting with an electrolyte solution, and shows similar behavior to a pure semiconductor such as silicon or germanium and electrical capacity is improved.

In addition, the inventors reported that adjacent CNTs strongly bind together due to Van De Waals force after exposing the orientation CNT bulk aggregate to a liquid and drying to create high density growth, these CNTs are orientated in a certain direction and the density per unit volume of an electrode material is preferably 0.2-1.0 g/cm³ or more preferably 0.5-0.9 g/cm³ or even more preferably 0.6-0.7 g/cm³, and it is possible to significantly increase the electrical capacity per unit volume when a high density grown orientated CNT bulk aggregate is used.

In addition, when a super growth method is used as described below, because it is possible to easily separate CNTs from catalyst particles (metal particles) formed on a substrate, it is possible to reduce metal particles from being brought into CNTs used in an electrode. However, because the electric double-layer capacitor described above has a stable operation of around 2.5V including charging and discharging, the inventors further examined realizing a long lifetime electric double-layer capacitor which operates at a high voltage exceeding 3V.

### Embodiment

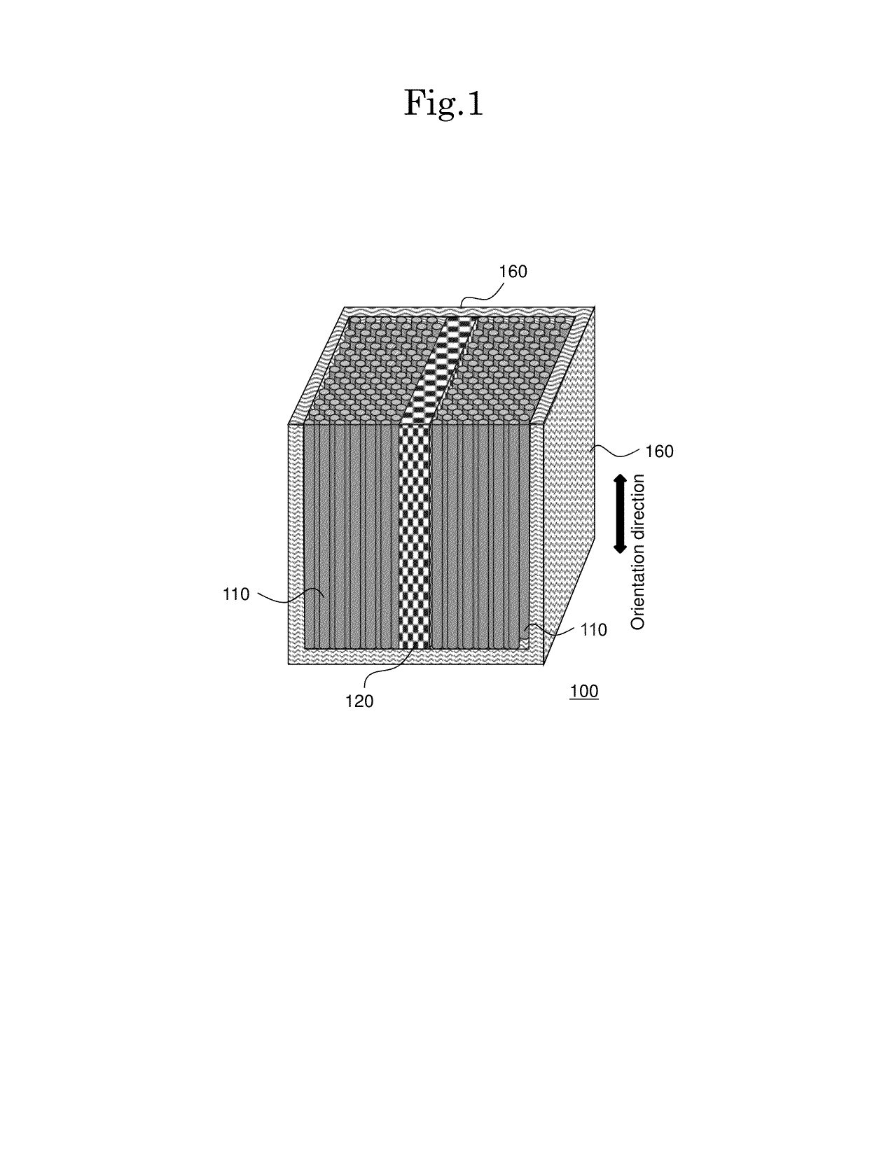

A diagram of an electric double-layer capacitor 100 related to an embodiment of the present invention is shown in FIG. 1.

The electric double-layer capacitor 100 related to an embodiment of the present invention includes a polarizing electrode 110, an ion permeable separator 120 and a barrier component 160. In the electric double-layer capacitor 100 related to an embodiment of the present invention, the separator 120 is arranged between a first polarizing electrode and second polarizing electrode comprised of two polarizing electrodes 110 so as to face the electrodes and the first polarizing electrode and second polarizing electrode are immersed in an electrolyte solution. The barrier component 160 is arranged so as to encompass the polarizing electrode 110 and separator 160 and it is possible to seal the electrolyte solution to the polarizing electrode 110 and separator 120 using the barrier component 160. Furthermore, because FIG. 1 explains an internal structure the upper surface and front barrier component 160 are not shown.

In the separator 120 in the electric double-layer capacitor 100 it is sufficient that the two polarizing electrodes be electrically insulated and cellulosic special paper or a porous resin sheet, resin woven fabric, glass fibrous woven fabric, porous ceramic sheet can be used. In addition, the two polarizing electrodes may be separated by spatial intervals. In addition, the barrier component 160 may be a form or material which can seal an electrolyte solution, and it is possible to form the barrier 160 using only a conventional seal material, for example, it is possible to apply various polymers such as a polyimide film or a plastic. In addition, the barrier component 160 is not limited to this as long as it does not restrict the functions of the electric double-layer capacitor 100, is chemically stable and is light. It is preferred that an organic electrolyte solution is used for the electrolyte solution being sealed at the polarizing electrode 110 and separator 120 of the electric double-layer capacitor 100 of the present invention. For example, it is possible to use an organic solute such as tetraethylammonium tetrafluoroborate or tetraethylammonium hexafluorophosphate, tetrabutylammonium perchlorate or an inorganic solute comprised from a cation such as lithium, quaternary phosphonium and an anion such as BF₄⁻, PF₆⁻, ClO₄⁻, CF₂SO₂⁻ dissolved in a non-protonic solvents such as propylene carbonate, 1-butylene carbonate, sulfolane, acetonitrile, γ-Butyrolactone, dimethylformamide. The electric double-layer capacitor 100 can operate at a high voltage with a long lifetime by using an organic electrolyte solution.

It is possible to obtain the carbon nanotube aggregate used in the polarizing electrode 110 related to the present embodiment of the present invention by peeling a vertically aligned structure of a single-walled CNT synthesized using the super growth method and performing a high density growth process described below. The relative surface area of the carbon nanotube aggregate used in the polarizing electrode 110 is preferred to be 800 m²/g or more and more preferably 1,000 m²/g or more if unopened single-walled CNTs are mainly present. The relative surface area of the carbon nanotube aggregate used in the polarizing electrode 110 is preferred to be 1,300 m²/g or more and more preferably 1,500 m²/g or more if opened single-walled CNTs are mainly present. While it is preferred that the relative surface area of the carbon nanotubes be as large as possible, it is explained that an unopened single-walled CNT has about 1,300 m²/g of surface area and an opened single-walled CNT has about 2,600 m²/g of surface area according to a logical calculation. In addition, a carbon nanotube aggregate which includes this high relative surface area is favorably used in an electric double-Layer capacitor. A carbon nanotube aggregate which mainly includes single-walled CNTs in which relative surface area does not reach 800 m²/g, may include a few ten percentage points (about 20%) of metal impurities or carbon impurities, can not realize the original functions of a CNT and is not suitable for use in a polarizing electrode.

Here, the conductivity of the carbon nanotube aggregate and/or the polarizing electrode 110 in the present invention is preferred to be 0.5 S/cm or more and more preferably 1 S/cm or more. Because the function of the polarizing electrode 110 increases the higher the upper limit of conductivity becomes, it is preferable that an electrode partially connected to the polarizing electrode 110 is small (or unnecessary). However, it is sufficient if conductivity is 500 S/cm or less and is assumed to be 1000 S/cm or less due to the conductivity of the carbon nanotubes themselves.

Because an unopened single-walled CNT is chemically stable due to having few chemical reactants it is possible for a carbon nanotube aggregate comprised mainly of unopened single-walled CNTs to be favorably used in a polarizing electrode which operates at a high voltage. And because the relative surface area of an opened single-walled CNT is very large it is possible for a carbon nanotube aggregate comprised mainly of opened single-walled CNTs to be favorably used in a polarizing electrode which operates at a high energy density.

It is possible to calculate the relative surface area of a carbon nanotube aggregate by measuring an absorption/desorption isotherm curve at 77K of liquid nitrogen. An absorption/desorption isotherm curve of a carbon nanotube consisting mainly of unopened single-walled CNTs shows high linearity in a region where relative pressure is 0.5 or less. In addition, an αₛ plot also shows linearity at a region of 1.5 or less. An absorption/desorption isotherm curve of a carbon nanotube consisting mainly of opened single-walled CNTs has a large initial absorption rise and shows a convex shape at a region where relative pressure is 0.5 or less. In addition, an αₛ plot shows a comparatively large increase rate in the amount of absorption in a region of 0.7 or less and a comparatively small increase rate in a region exceeding 0.7 and shows a convex shape in a region of 1.0 or less. That is, it is possible to categorize a CNT into an unopened or opened CNT by measuring an absorption/desorption isotherm curve.

The minimum weight density of a carbon nanotube aggregate is 0.3 g/cm³ or preferably 0.4 g/cm³ or more preferably 0.5 g/cm³ and the maximum weight density is 1.5 g/cm³ or preferably 1.2 g/cm³ or more preferably 1.0 g/cm³. Because a carbon nanotube aggregate which is within this weight density range has sufficient mechanical strength, a large relative surface area, high conductivity and a pore size which can be accessed by ions and volume is small it is possible to favorably use the aggregate in a polarizing electrode.

When the weight density is smaller than 0.3 g/cm³, the aggregate becomes mechanically brittle and mechanical strength can no longer be obtained. When the weight density is smaller than 0.4 g/cm³, volume increases and it becomes disadvantage when manufacturing a small scale electric double-layer capacitor. A carbon nanotube aggregate having a weight density range of 0.5 g/cm³ or more and 1.0 g/cm³ or less has a pore size which can be favorably accessed by ions and the aggregate can be favorably used in a polarizing electrode. When the weight density is larger than 1.0 g/cm³, the pore size decreases and access by anion ions begins to be blocked. When the weight density is larger than 1.2 g/cm³, the pore size decreases and access by cation ions begins to be blocked. When the weight density is larger than 1.5 g/cm³, CNT pairs which form the carbon nanotube aggregate begin to stick together and relative surface area decreases.

Although described in detail below, when high density growth of the carbon nanotube aggregate used in the polarizing electrode related to the present embodiment of the present invention is performed using water, alcohols (isopropanol, ethanol, methanol), acetones (acetone), hexane, toluene, cyclohexane, DMF (dimethylformamide) etc described in Japanese Laid Open Patent 2007-182352, the solvent which is used remains in the carbon nanotube aggregate, the remaining liquid reacts under high voltage conditions, and as well as obstructing operation of the electric double-layer capacitor under high voltage conditions also reduces longevity. In order to solve this problem, it is sufficient to perform high density growth using the same electrolyte solution as the electrolyte solution which is immersed in the polarizing electrode 110 of the electric double-layer capacitor 100 of the present embodiment. In the electric double-layer capacitor 100 of the present embodiment, favorable operation at a high voltage over a long lifetime is possible by performing high density growth using an organic electrolyte solution.

As shown in FIG. 1, the polarizing electrode 110 related to the present embodiment is formed by a carbon nanotube aggregate including high conductivity and high purity and the carbon nanotube aggregate is arranged orientated in a parallel direction to the separator 120. In the present embodiment, the carbon nanotube aggregate of the polarizing electrode 110, for example, as typical values, has a single-walled CNT contained ratio of 99% or more (ratio of the number of single-walled CNTs with respect to double layer CNTs and multi-layer CNTs calculated from a transmission type electron microscope image of the carbon nanotube aggregate), a BET-relative surface area of 800 m²/g or preferably 1,000 m²/g or more and 2,600 m²/g or less, a density of 0.5 g/cm³ or more and 1.5 g/cm³ or less, a pore size distribution maximum of 1 nm or more and 10 nm or less, metal impurities of 1 mass % or less, a carbon purity of 98 mass % or more, a conductivity of 100 S/D or less, a G/D ratio of 2.5-40, an average external diameter of 2.8 nm, a half value width of 2 nm, and Herman orientation factor of 0.7. Because the relative surface area of a single-walled CNT is large compared to a double-layer CNT or multi-layer CNT, a carbon nanotube aggregate consisting mainly of single-walled CNTs can be favorably used in a polarizing electrode.

It is preferred that the polarizing electrode 110 and/or carbon nanotube aggregate related to the present embodiment have a carbon purity of 98 mass % or more and/or a metal impurity mass of 1 mass % or less. The impurities react with the electrolyte solution (secondary reaction) under an applied voltage, and as well as obstructing the operation of the electric double-layer capacitor under a high voltage also reduces the longevity of the capacitor. A electric double-layer capacitor which includes a carbon nanotube aggregate and/or the polarizing electrode 110 having a carbon purity of 98 mass % or more and/or a metal impurity mass of 1 mass % or less is favorable since the secondary reaction described above is controlled and as well as being able to operate at a high voltage has a longer lifetime. Although there is no upper limit to the carbon purity, it is difficult to obtain a carbon purity of 99.9999% or more considering manufacturing conditions. Although there is no lower limit to metal impurities, it is difficult to obtain metal impurities of 0.0001% or less considering manufacturing conditions. If carbon purity does not reach 95%, it is difficult obtain a relative surface area which exceeds 1,000 m²/g in the case of unopened single-walled CNTs. When carbon purity is 98% or less and/or metal impurities are 1 mass % or less, a secondary reaction occurs under an applied voltage and as well as obstructing the operation of the electric double-layer capacitor at a high voltage the longevity of the capacitor is reduced.

The carbon nanotube aggregate used on the polarizing electrode 110 related to the present embodiment of the present invention has a pore size distribution maximum lower limit of 1 nm or more and preferably 2 nm or more and a pore size distribution maximum upper limit of 10 nm or less and preferably 5 nm or less. When a pore size carbon nanotube aggregate is used in a polarizing electrode, because ions can be rapidly dispersed in the carbon nanotube aggregate, it is possible to favorably realize a high power electric double-layer capacitor. In addition, when the pore size distribution maximum lower limit is 2 nm or less, ions begin to be blocked from being dispersed in the carbon nanotube aggregate, and when the lower limit is 1 nm or less, dispersion becomes difficult. In addition, when the pore size distribution maximum upper limit is 5 nm or more, the volume of the carbon nanotube aggregate increases and the size of the electric double-layer capacitor increases. When the pore size distribution maximum upper limit is 10 nm or more, because mechanical strength within the carbon nanotube aggregate decreases, it becomes difficult to manufacture a stable electric double-layer capacitor.

Here, nano size pore size between single-walled CNTs can be calculated from an absorption/desorption isotherm curve at 77K of liquid nitrogen. As a logical equation for calculating a pore size distribution, a BJH method (see J. Amer. Chem. Soc., Volume 73 (1951), page 373) which assumes that a pore has a cylinder shape can be used. Pore size as defined in the present specification is calculated using a BJH method from an absorption/desorption isotherm curve at 77K of liquid nitrogen.

The polarizing electrode 110 related to the present embodiment includes a high level of orientation when high density growth is performed by using a carbon nanotube aggregate formed with uniform single-walled CNTS and with high selectivity. Because a single-walled CNT is by carbon bonding, it is possible to provide a sufficiently stable polarizing electrode 110 even under high voltage conditions. As described above, because a carbon nanotube aggregate does not include hardly any metal impurities and uses only an electrolyte solution even in high density growth, a binder such as an AC electrode is not required. In addition, because the polarizing electrode 110 does not contain other conductive elements or functional groups on a surface such as in an AC electrode, it is possible to chemically stably operate the polarizing electrode 110 formed to a high purity even under high voltage conditions. However, because an AC electrode requires a binder, chemical stability cannot be guaranteed under high voltage conditions.

In addition, although a polarizing electrode is arranged orientated perpendicularly with respect to a current collector 450 and separator 120 in the electric double-layer capacitor reported in Japanese Laid Open Patent 2007-81384, as is shown in FIG. 1 (a), the polarizing electrode 110 related to the present invention is arranged in a parallel orientation with respect to the separator 120. The polarizing electrode 110 formed in a parallel orientation with respect to the separator 120 can easily be made into a thin electrode. In addition, it is easy to provide a polarizing electrode with the functions of a current collector using the conductivity of a carbon nanotube aggregate and unlike a conventional electric double-layer capacitor, it is possible to operate the capacitor even under high voltage conditions without arranging a current collector facing the entire surface.

In addition, the polarizing electrode 110 in the present embodiment shows excellent electrical and electrochemical properties by using a carbon nanotube aggregate which is high purity and comprised from single-walled CNTs orientated parallel to the separator 120, and includes the functions of an electrode and functions of a current collector. Because the conductivity of an electrode is low in a conventional electric double-layer capacitor, it is necessary to arrange a current collector on the entire side surface of a pair of AC electrodes arranged facing each other. As is shown in FIG. 1, in the electric double-layer electrode 100 related to the present embodiment of the present invention, because conductivity of a carbon nanotube aggregate which forms the polarizing electrode 110 is high, it is not necessary to arrange current collectors facing each other on the entire side surface of the polarizing electrode 110. That is, in the electric double-layer electrode 100 related to the present embodiment of the present invention, because the polarizing electrode 110 itself has the function of a current collector, it is sufficient to extract a charge from the polarizing electrode 110. Therefore, in the electric double-layer electrode 100 related to the present embodiment of the present invention, it is sufficient to make an electrical connection by arranging an electrode on a part of one end of the polarizing electrode 110 in order to collect the charge flowing through the polarizing electrode 110. An electrode for extracting this type of charge may be electrically connected with the polarizing electrode 110, it is not necessary to cover the entire side surface of the polarizing electrode 110, it is possible to partially make a connection to arbitrary parts and the entire side surface of the polarizing electrode 110 may also be covered. In this case, because conductivity in an orientation direction of the carbon nanotube aggregate is high, it is favorable to connect an electrode with the polarizing electrode 110 while in a state extending perpendicular to the orientation direction. The polarizing electrode 110 arranged in this way plays the role of a current collector, and a charge flows in a horizontal direction (first direction) and perpendicular direction (second direction which intersects the first direction) within the polarizing electrode 110 toward the electrode or from the electrode towards to polarizing electrode 110. in this way, a charge flowing in a perpendicular direction and horizontal direction within the polarizing electrode 110 is one feature of the electric double-layer capacitor 100 of the present invention.

Because the polarizing electrode 110 also functions as a current collector by using a high conductivity carbon nanotube aggregate in the polarizing electrode 110, the electric double-layer capacitor 100 unlike a conventional electric double-layer capacitor can operate even under high voltage conditions even without arranging a current collector on the entire surface so as to face each other. Therefore, by using the polarizing electrode 110 which also includes the function of a current collector in the electric double-layer capacitor 100 related to the present embodiment of the present invention, it is possible to provide a small and light weight electric double-layer capacitor compared to a conventional electric double-layer capacitor which requires a current collector. Here, as described above, the conductivity of the carbon nanotube aggregate used in the polarizing electrode 110 and/or the polarizing electrode 110 is 0.5 S/cm or more and preferably 1 S/cm or more. Because the function of the polarizing electrode 110 as a current collector increases the higher the upper limit of the conductivity is, the smaller (or unnecessary) the electrode partially connected to the polarizing electrode becomes which is favorable. However, it is sufficient that conductivity is 500 S/cm or less and is assumed to be 1,000 S/cm or less due to the conductivity of the carbon nanotubes themselves. In the case where the conductivity of the carbon nanotube aggregate and/or the polarizing electrode 110 is 0.5 S/cm or less, the weaker the function of the polarizing electrode 110 as a current collector becomes and therefore it is desirable to orient a current collector facing the entire surface the same as a conventional electric double-layer capacitor. In the case where the conductivity of the carbon nanotube aggregate and/or the polarizing electrode 110 is 1 S/cm or less, the polarizing electrode 110 still functions as current collector, however it becomes difficult to arbitrarily set the size of an electrode.

The contact area of the polarizing electrode 110 and an electrode is preferred to be 1% or more and 50% or less of the total surface area of the external side surface of the polarizing electrode 110. When the contact area of the polarizing electrode 110 and an electrode is within this range, the polarizing electrode 110 continues to function as a current collector and it is possible to provide a light weight and small scale electric double-layer capacitor. When the contact area is 1% or less of the total surface area, degradation is observed in a large scale electric double-layer capacitor and when the contact area is 50% or more of the total surface area, a high performance electric double-layer capacitor is obtained. However, the electric double-layer capacitor becomes heavier by the weight of an electrode.

A current collector uniforms the potential within an electrode and the distribution of a potential within an electrode is made to exist only in the thickness direction of the electrode. In the case where a current collector is not arranged on an AC electrode, because the conductivity of the electrode is low, a conventional electric double-layer capacitor can no longer operate. In the electric double-layer capacitor 100 related to the present invention in the present embodiment, the polarizing electrode 110 also includes the function of a current collector and by providing the polarizing electrode 110 with better electrical characteristic than an AC electrode, it is possible to be operated under high voltage conditions without arranging a current collector on the entire surface so as to face each other. In this way, a light weight and small scale electric double-layer capacitor 100 related to the present invention of the embodiments can be provided.

The relationship between the characteristics of a polarizing electrode used as the polarizing electrode related to present embodiment described above and the effects on an electric double-layer capacitor is shown in table 1.

TABLE 1

| Characteristics of a | Single-walled | | Effects on an electric |
|---|---|---|---|
| polarizing electrode | CNT | AC | double-layer capacitor |
| Structure | Hollow Fiber | Particle | Lifetime |
| Surface area [m²/g] | ≧800 | 1,000-2,000 | Energy |
| Composition | Carbon Only | Carbon & | Voltage, Lifetime |
| | | Functional | |
| | | Groups | |
| Tortuosity | Low | High | Power |
| Conductivity [S cm⁻¹] | High (21) | Low (0.3) | Current-collector |
| | | | (Weight) |

By forming the polarizing electrode used as the polarizing electrode in the present embodiment using a carbon nanotube aggregate made from very pure carbon and having few impurities, it is possible to operate the electrode under high voltage conditions, chemical reactions of an electrolyte solution can be controlled to a minimum and it is possible to realize an electric double-layer capacitor having a long lifetime by forming it with a carbon nanotube aggregate having high conductivity. In addition, by using a carbon nanotube aggregate which is high density grown and includes an appropriate pore size, it is possible to realize an electric double-layer capacitor in which ions can be easily dispersed and having a high power. In this way, the electric double-layer capacitor related to the present invention can be driven at a driving voltage of 3.5V or more and less than 4.5V as is shown in the Examples. Furthermore, by using a carbon nanotube aggregate having a high conductivity, the polarizing electrode functions as a current collector and a charge flows not only in a perpendicular direction but also in a horizontal direction within the polarizing electrode 110. As a result, it is not necessary to use a conventional current collector and it is possible to provide a light weight and small scale electric double-layer capacitor. Therefore, the electric double-layer capacitor of the present invention related to the present embodiment can operate under a high voltage over a long lifetime and includes a larger electrical density and power density compared to a conventional electric double-layer capacitor.

### Examples

Examples of the electric double-layer capacitor related to the present invention described above are explained in detail below. Furthermore, the Examples below are merely examples are the electric double-layer capacitor of the present invention should not to be limited to these examples.

### Example 1

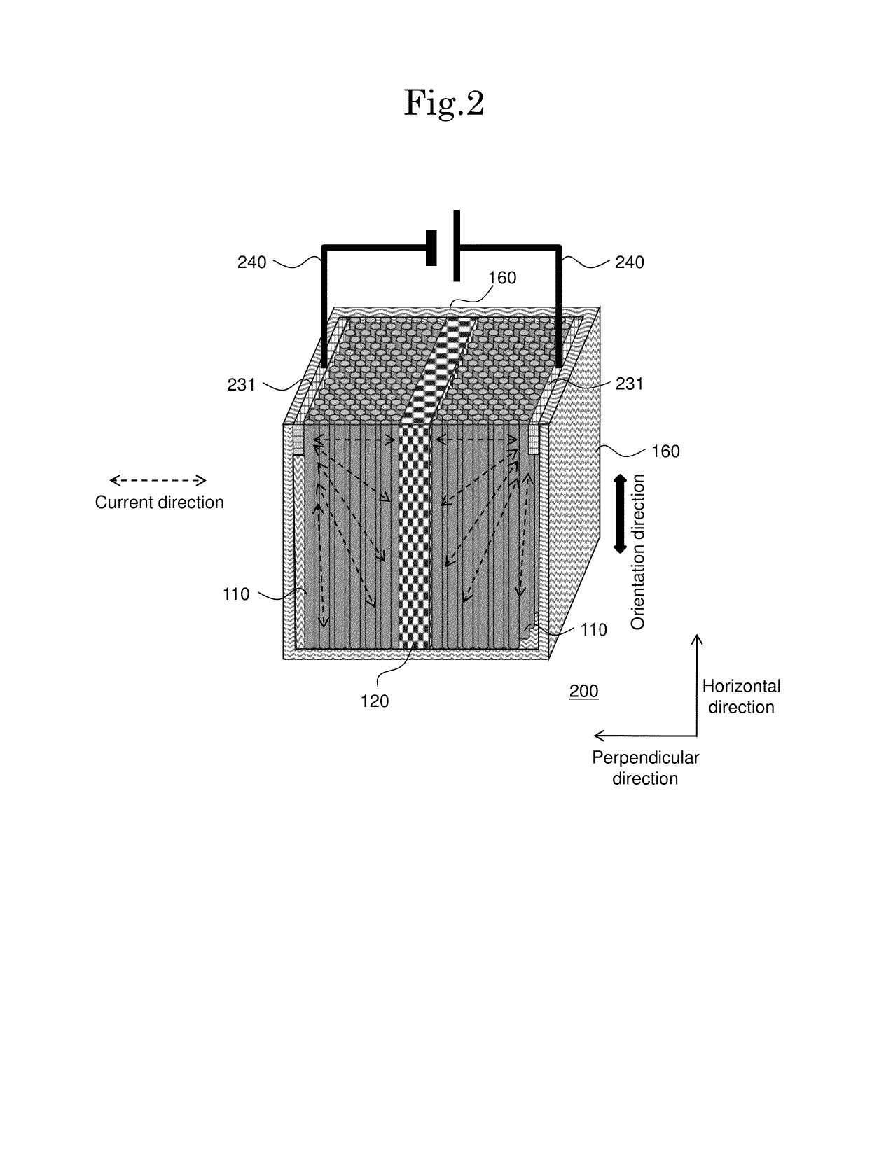

A diagram of an electric double-layer capacitor 200 related to the example of the present invention is shown in FIG. 2.

The electric double-layer capacitor 200 of the present invention related to the present example includes two polarizing electrodes 110, a first polarizing electrode and a second polarizing electrode, an ion permeable separator 120 and a barrier component 160. In addition, the electric double-layer capacitor 200 of the present invention related to the present example includes an electrode 231 for extracting a charge and an external electrode terminal 240. In the electric double-layer capacitor 200 of the present invention related to the present example, the separator 120 is arranged between the first polarizing electrode and the second polarizing electrode 110 so as to face the electrodes, and the electrode 231 is arranged on a part of an exterior side surface of the polarizing electrodes 110 which face each other and extending in a perpendicular direction to the orientation direction of CNT nanotubes of a carbon nanotube aggregate. In addition, the external electrode terminal 240 is arranged on the electrode 231 and the polarizing electrodes 110 are immersed in an electrolyte solution. By adopting this structure, the polarizing electrode 110, electrode 231 and external electrode terminal 240 are electrically connected with each other. The barrier component 160 is arranged so as to encompass the polarizing electrode 110, the separator 160 and electrode 231 and it is possible to seal the electrolyte solution to the polarizing electrode 110 and separator 120 using the barrier component 160. In FIG. 2, the electric double-layer capacitor 200 is an example where the electrode 231 is arranged on an end part of an external side surface of the first polarizing electrode and second polarizing electrode. Furthermore, because FIG. 2 explains an internal structure the upper surface and front barrier component 160 are not shown.

### (Manufacturing Method)

The manufacturing method of the electric double-layer capacitor 200 is explained in detail below. The electric double-layer capacitor 200 related to the Example 1 of the present invention uses single-walled CNTs and is operated at a voltage of 3.5V or more and less than 4.5V. Because the electrode 231 does not cover the entire side surface of the polarizing electrode 231, the polarizing electrode 110 plays the role of a current collector and as is shown by the arrow in FIG. 2, a charge flows in a horizontal direction and perpendicular direction within the polarizing electrode 110 towards the electrode 231.

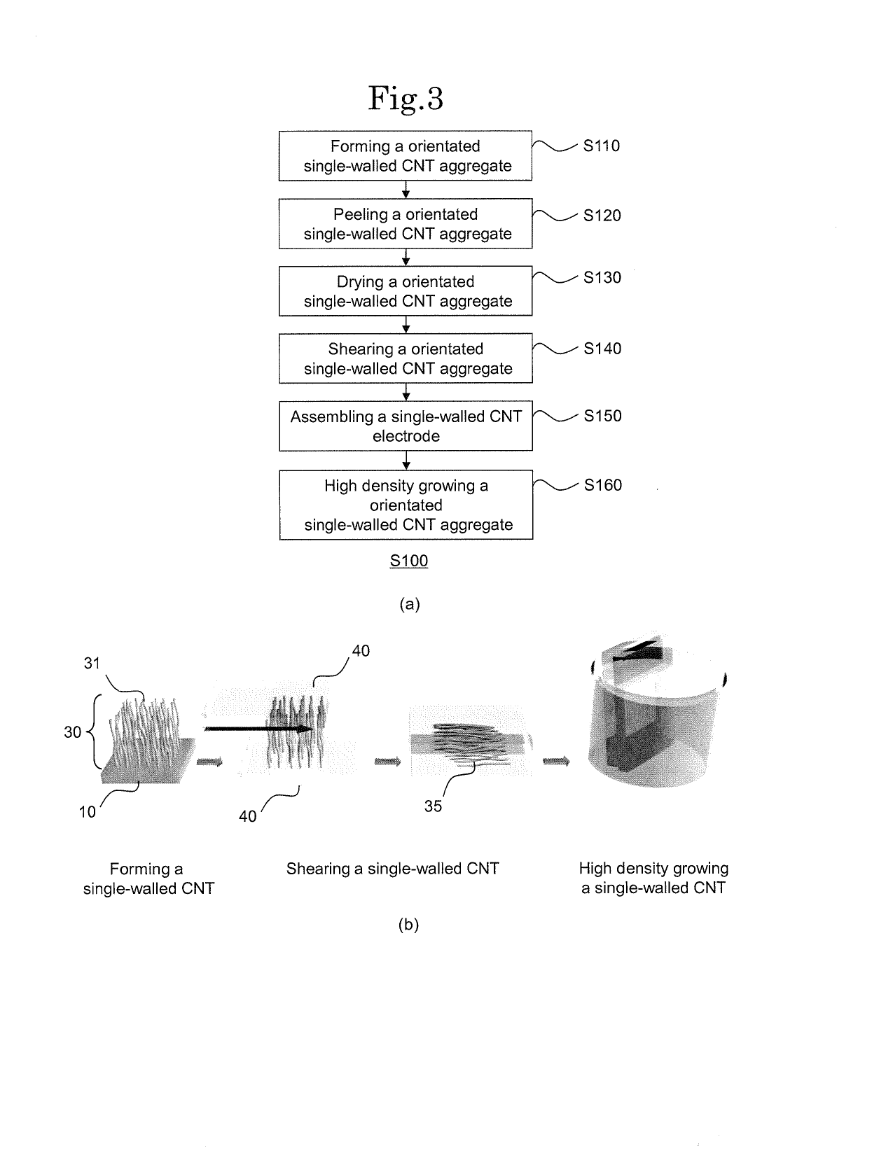

A manufacturing step S100 of the electric double-layer capacitor 200 related to Example 1 is shown in FIG. 3. FIG. 3 (a) is a flowchart of the manufacturing step S100 of the electric double-layer capacitor 200 related to Example 1 and FIG. 3 (b) is a diagram. The manufacturing step S100, for example, includes a step S110 for forming a carbon nanotube aggregate used as the polarizing electrode, a step S120 for peeling the carbon nanotube aggregate, a step S130 for drying the carbon nanotube aggregate, a step S140 for shearing the carbon nanotube aggregate, a step 150 for assembling the polarizing electrode and a step S160 for high density growth of the carbon nanotube aggregate.

Step S110 for forming the carbon nanotube aggregate is a step for the forming carbon nanotube aggregate orientated in a perpendicular direction to the surface of a substrate. In S110 for forming the carbon nanotube aggregate related to Example 1, the carbon nanotube aggregate is formed using a super growth method which is a CVD method performed under a condition in which water vapor is added as reported previously by the inventors. The carbon nanotube aggregate 30 is formed by forming catalyst particles (not shown in the diagram) on the substrate 10 and by growing single-walled CNTs 131 from the catalyst particles in a perpendicular direction to the surface of the substrate.

It is possible to use a non-metallic component which can support a catalyst for growing CNTs on the surface of the substrate and any appropriate component that can maintain its shape at a high temperature of 400° C. or more as the substrate 10 for forming the carbon nanotube aggregate 30. In Example 1, a 10 mm×10 mm silicon substrate is used as the substrate 10.

In Example 1, iron is used as a catalyst and alumina (Al₂O₃) is used as a supporting catalyst. A high frequency sputtering deposition method is used for forming a catalyst layer on the surface of the substrate. A 10 nm thick supporting catalyst layer comprised of alumina (Al₂O₃) is formed on the upper surface of the substrate 10 and a 1 nm thick catalyst layer comprised from iron (Fe) is formed on the alumina layer (S112). In this way, the substrate formed with a catalyst layer is reduced and catalyst particles are formed.

The substrate 10 formed with a catalyst layer is conveyed to and set inside of a synthesis furnace of a CVD device held at a furnace pressure of 1.02×10⁵ Pa, and a ratio of 600 sccm of He as an atmospheric gas and 400 sccm of H₂ as a reducing gas are introduced from a gas supply conduit over 15 minutes so that the total amount of a gas flow within the synthesis furnace becomes 1,000 sccm. The temperature with the furnace is raised to 750° C. from room temperature over these 15 minutes.

Next, a water addition process is performed by supplying 510 sccm of He (atmospheric gas), 400 sccm of H₂ (reducing gas) and 90 sccm of He containing H₂O (relative humidity of 23%) (catalyst activator material mixed into a carrier gas) for 5 minutes to the inside of the synthesis furnace held at a furnace temperature of 750° C. and a furnace pressure of 1.02×10⁵ Pa (air pressure).

Next, CNT 13 is formed by supplying 850 sccm of He (atmospheric gas), 100 sccm of ethylene (C₂H₄) (raw material gas) and 50 sccm of He containing H₂O (relative humidity of 23%) (catalyst activator material mixed into a carrier gas) for 5 minutes to the inside of the synthesis furnace held at a furnace temperature of 750° C. and a furnace pressure of 1.02×10⁵ Pa (air pressure) so that the total gas flow amount becomes 1,000 sccm, and the carbon nanotube aggregate 30 is obtained. In the present example, the density of the carbon nanotube aggregate 30 was 0.03 g/cc.

The carbon nanotube aggregate 30 obtained in this way is peeled from the catalyst particles formed on the substrate 10 (S120). It is possible to peel the carbon nanotube aggregate 30, for example, by lightly pushing the carbon nanotube aggregate 30 in a horizontal direction within respect to the substrate 30 using tweezers. The carbon nanotube aggregate 30 which is peeled off had an area of 10 mm×10 mm, a thickness of 500 μm-1 mm, a carbon purity of 99.9%, metal impurities of 0.013 mass % and a relative surface area of 1,100 m²/g. The carbon nanotube aggregate is provide with binding power by having a length of 500 μm-1 mm and can be grown with high density.

Because a reaction is produced under a high voltage when metal particles remain in the carbon nanotube aggregate 30, it is important to peel the carbon nanotube aggregate 30 from the catalyst particles formed on the substrate 10 so that metal particles such as an iron catalyst are not left on the carbon nanotube aggregate 30. In the carbon nanotube aggregate 30 of Example 1 related to the present invention, because a Single-walled CNT 31 is grown from catalyst particles formed on the substrate 10, in the peeling process of the carbon nanotube aggregate described above, almost no catalyst particles are detached from the substrate 10 and almost no catalyst particles are left on the carbon nanotube aggregate 30.

Next, the peeled carbon nanotube aggregate 30 is vacuum dried for 8 hours or more at 150° C. (S130). The carbon nanotube aggregate 30 is semi-high density grown (density 0.2 g/cc) by shearing between slide glass 40 so that the carbon nanotube aggregate 30 orientated in a perpendicular direction transforms into a single-layer orientated sheet 35 orientated in a horizontal direction under an inactive environment (a glove box is filled with argon and the oxygen concentration is 2 ppm or less and dew point temperature is −80° C. or less) (S140). Here, it is important to minimize the remaining amount of water vapor and oxygen within the polarizing electrode 110 in order to operate at a high voltage. Therefore, it is necessary to perform subsequent steps under the inactive environment described above.

A 40 μm thick cellulose porous paper used as the separator 120 is sandwiched in between so that two semi-high density grown single-walled CNT orientated sheets 35 having the same weight and thickness (9 mm×9 mm×0.75 mm) face each other and the electric double-layer capacitor 200 is assembled (S150). Next, the platinum mesh electrode 231 is arranged on an end part of the two single-walled CNT orientated sheets 35 respectively. The contact area of the electrode 231 is 5% of the total surface area of the external side surface of the polarizing electrode 110. Because the electrode 231 does not cover the entire side surface of the polarizing electrode 110, the polarizing electrode 110 plays the role of a current convertor and a charge flows in a horizontal direction and a perpendicular direction within the polarizing electrode 110 towards the electrode 231.

Here, because the same size voltage (2V+2V) is applied to the two polarizing electrodes 110, it is important to use polarizing electrodes having the same weight (same thickness). When one electrode is heavier (thicker) than the other, the voltage distribution becomes non-uniform, an excessive current flow to the lighter (thinner) electrode and the capacitor breaks.

The assembled electric double-layer capacitor 200 is filled with an organic electrolyte solution and a single-walled CNT oriented sheet 35 is high density grown. In the electric double-layer capacitor 200 related to the present example of the present invention it is preferred to use an organic based electrolyte solution rather than a water based electrolyte solution. By using an organic based electrolyte solution it is possible to operate the capacitor under high voltage conditions. The same electrolyte solution that is sealed in the polarizing electrode 110 and separator 120 of the electric double-layer capacitor 200 is used for the organic electrolyte solution used for high density growth and in the present example, a 1M tetraethylammonium tetrafluoroborate in propylene carbonate solution is used. In order to completely immerse the electrolyte solution in the polarizing electrode 110 and completely remove gas from within the capacitor, the electric double-layer capacitor 200 is left for 30 minutes in a vacuum (100 Torr or less). By immersing the electrolyte solution the semi-high density grown single-walled CNT orient sheet 35 is high density grown to form the polarizing electrode 110 and good access to the surface of the electrode by ions is secured. Here what is important is that electrolyte solution is immersed in the polarizing electrode 110. When the polarizing electrode is high density grown in a liquid other than an electrolyte solution, the liquid which remains even after vacuum drying is absorbed into the surface of the single-walled CNT, the remaining liquid reacts under a high voltage and the operation of the electric double-layer capacitor is obstructed at 4V.

The characteristics of the high density grown carbon nanotube aggregate which forms the polarizing electrode 110 obtained in this way can be evaluated by measuring the characteristics of the carbon nanotube aggregate which is high density grown using only a solvent (propylene carbonate solution). The carbon nanotube aggregate which is high density grown in the present example had a conductivity of 20 S/cm, single-walled CNT content rate of 99.9%, a density of 0.5 g/cm³, a G/D ratio of 2.5-40, a BET-relative surface area of 1,100 m²/g, an average external diameter of 2.8 nm, a half value width of 2 nm, a carbon purity of 99.9 mass %, metal impurities of 0.013 mass %, pore size distribution maximum of 4 nm and Herman orientation factor of 0.7. The polarizing electrode 110 had a conductivity of 7 S/cm and was 300 S/cm after being polarized. The content amount of metal impurities was 0.008 mass % and the weight density was 0.93 g/cm³.

The polarizing electrode 110 formed with a high purity and high conductivity carbon nanotube aggregate is used as the polarizing electrode related to the present example of the present invention. In this way, ion access within the electrolyte solution of the electric double-layer capacitor is improved, and as is described below it is possible to provide an electric double-layer capacitor which can be used under high voltage conditions. The electric double-layer capacitor 200 assembled in this way is arranged with a barrier component 160 and an electrolyte solution is sealed. The barrier component 160 may have any form or material which can seal the electrolyte solution airtight and can be formed using only a conventional seal material, for example, various polymers such as a polyimide film or plastic can be used. In addition, the material used is not limited to these as long as it is chemically stable, lightweight and does not limit the functions of the electric double-layer capacitor 200. It is preferred that an organic based electrolyte solution is used as the electrolyte solution for sealing the polarizing electrode 110 and separator 120 of the electric double-layer capacitor 200 of the present example. In the present example, a 1M tetraethylammonium tetrafluoroborate in propylene carbonate solution is used for high density growth of the single-walled CENT oriented sheet 35. By using an organic based electrolyte solution the electric double-later capacitor 200 can be operated at a high voltage of a long lifetime.

As is shown in FIG. 2, in the polarizing electrode 110 of the present example the carbon nanotube aggregate is arranged to be orientated in a parallel direction to the separator 120 and the electrode 231 is partially connected to the side surface of the polarizing electrode 110. The polarizing electrode 110 used as the polarizing electrode in the present example shows excellent electrical properties by using a high purity and high conductivity carbon nanotube aggregate and includes the function of an electrode and the function of a current collector. In a conventional electrical double-layer capacitor it was necessary to arrange a current collector on the entire side surface of a pair of AC electrodes arranged to face each other. By using a high purity carbon nanotube aggregate in the polarizing electrode 110, conductivity increases, ion access within the electrolyte solution is improved and because the polarizing electrode 110 also functions as a current collector, the electric double-layer capacitor 200 can be operated even under high voltage conditions unlike a conventional electric double-layer capacitor by partially connecting the electrode 231 to the side surface of the polarizing electrode 110. That is, it is sufficient that the electrode 231 related to the present example of the present invention includes a function for extracting a charge from the polarizing electrode 110 and the function of a current collector is not required. Therefore, by combining the polarizing electrode 110 which includes the function of a current collector and the electrode 231 in the electric double-layer it is possible to provide a lightweight and small scale electric double-layer capacitor compared to a conventional electric double-layer capacitor which requires a current collector.

It is possible to use a metal such as aluminum or platinum or an alloy of these, a metal compound such as titanium nitride, a conductive polymer such as poly 3-methyl thiophene or a CNT rubber for the electrode 231 related to the present example of the present invention. In addition, the electrode 231 may be a thin film or a mesh shaped component and a component having a direct current electrical conductivity of 100 S/cm or more or a sheet resistance of 1 ohm/square or less.

The contact area and thickness of the electrode 231 are different depending on the component used but may be any material as long as it can collect a charge flowing through the polarizing electrode. The contact area of the electrode 231 may be equivalent to a part of the side surface of the polarizing electrode 110 described above. In addition, in the case where the electrode 231 is deposited on the polarizing electrode 110, it is possible to use a physical deposition method such as a sputtering method, heat resistance coating method or electron beam deposition, or a CVD method. In FIG. 2, the electrode 231 is arranged facing an end part of the two polarizing electrodes 110 arranged with the separator 120 therebetween. However, the electrode 231 is not limited to this arrangement and can be changed front and rear and left and right as long as a charge flowing through the polarizing electrode is collected. By using the electrode 231 in place of a conventional current collector in the electric double-layer capacitor 200 related to the present example it is possible to provide a lightweight and thin electric double-layer capacitor. Furthermore, the electrode 231 may cover the entire side surface of the polarizing electrode 110.

A current collector uniforms the potential within an electrode and the distribution of a potential within an electrode is made to exist only in the thickness direction of the electrode. However, by using the electrode 231 in the electric double-layer capacitor 200, the potential within an electrode distributes across the entire electrode. In the case where this type of electrode 231 is arranged on an AC electrode, because the conductivity of the AC electrode is low, a charge flowing through an electrode can no longer be collected and a conventional electric double-layer capacitor can no longer operate. In the electric double-layer capacitor 200 related to the present invention in the present example, the polarizing electrode 110 also includes the function of a current collector and by providing the polarizing electrode 110 with better electrical characteristic than an AC electrode, it is possible to use the electrode 231.

By forming the polarizing electrode used as the polarizing electrode in the present example from a carbon nanotube aggregate with a high carbon purity and few metal impurities, the capacitor can operate under high voltage conditions, a chemical reaction of the electrolyte solution can be controlled to a minimum and it is possible to realize an electric double-layer capacitor with a long lifetime by forming the capacitor with a high conductivity carbon nanotube aggregate. In addition, by using a high density grown carbon nanotube aggregate having an appropriate pore size, ions are easily dispersed and an electric double-layer capacitor with high power is realized. In this way, the electric double-layer capacitor related to the present example can be driven by a driving voltage of 3.5V or less or less than 4.5V as is shown in the example. Furthermore, by using a carbon nanotube aggregate having high conductivity, the polarizing electrode also functions as a current collector and a charge flows not only in a perpendicular direction but also in a horizontal direction within the polarizing electrode 110.

As a result, it is sufficient that an electrode connected to the polarizing electrode include a function for inputting and extracting a charge and it is possible to provide a lightweight and small scale electric double-layer capacitor without the need to use a conventional current collector. Therefore, the electric double-layer capacitor of the present invention related to the present embodiment can be operated at a high voltage and over a long lifetime and includes a large electrical density and power density compared to a conventional electric double-layer capacitor.

### Example 2

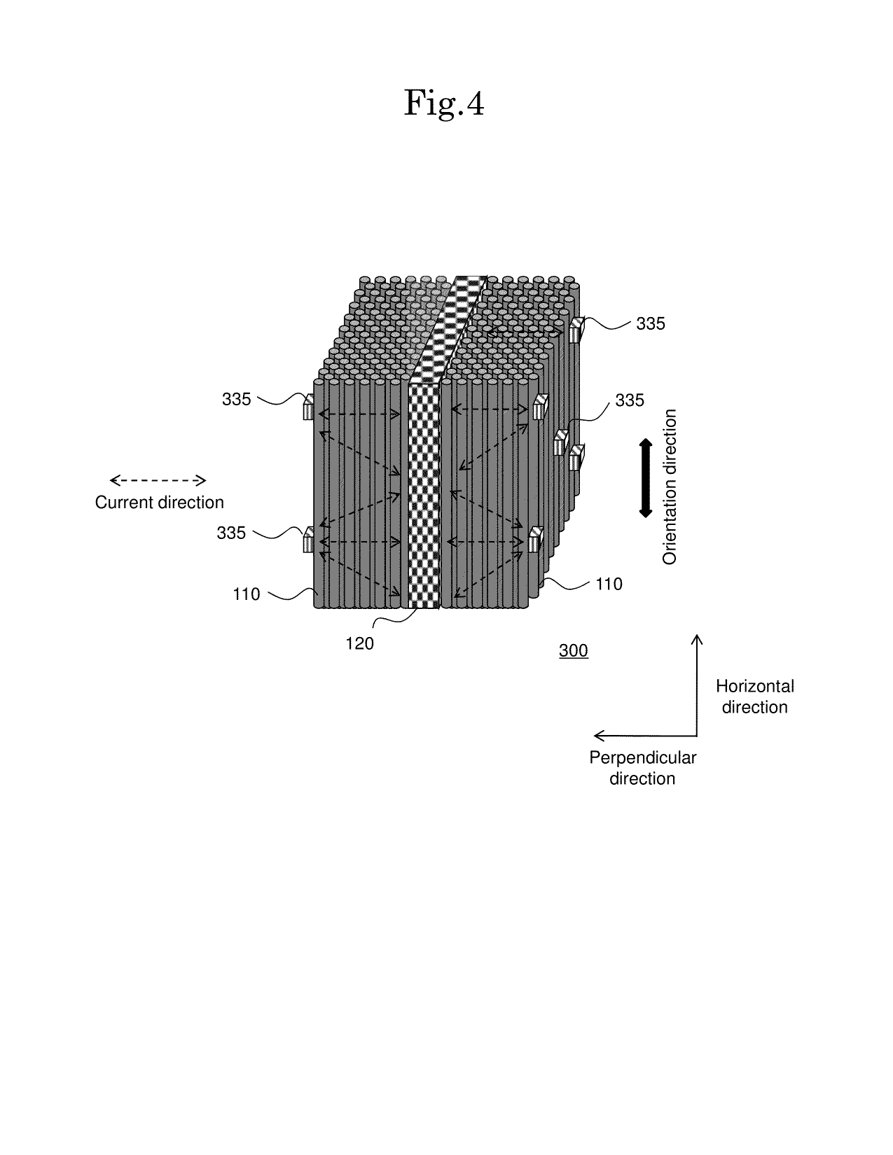

In the present example, as a modified example of Example 1, an example where a plurality of electrodes 335 are partially connected to the side surface of the polarizing electrode 110 used as the polarizing electrode and an electric double-layer capacitor 300 is electrically connected to the polarizing electrode 110 at a plurality of different places is explained. With this type of structure, even in a large scale polarizing electrode 110, it is possible to efficiently collect a charge flowing through the polarizing electrode 110 without using a current collector which covers the entire side surface. A diagram of the electric double-layer capacitor 300 related to Example 2 of the present invention is shown in FIG. 4. In the electric double-layer capacitor 300 a separator 120 is sandwiched by two polarizing electrodes 110 (first polarizing electrode and second polarizing electrode). A plurality of electrode 335 is partially connected to an external side surface of the polarizing electrode 110 and each is respectively connected to an external electrode terminal 240 (not shown in the diagram). The polarizing electrode 110 is filled with an electrolyte solution. With this structure, the polarizing electrode 110, the electrode 335 and the external electrode terminal 240 are electrically connected to each other. A barrier component 160 is arranged so as to encompass the polarizing electrode 110, separator 120 and the electrode 335 and it is possible to seal the electrolyte solution in the polarizing electrode 110 and separator 120 using the barrier component 160. In addition, because FIG. 4 explains an internal structure the barrier component 160 is not shown. Furthermore, the external electrode terminal 240 may be a circuit printed on a package of the barrier 160 of the electric double-layer electrode 300 which covers the polarizing electrode 110.

The polarizing electrode 110, separator 120 and electrolyte solution explained in Example 1 can be used in the electric double-layer electrode 300 related to Example 2 of the present invention and details related to each one are omitted here. It is possible to form the electrode 335 related to Example 2 of the present invention on the side surface of the polarizing electrode 110 using the same material as the electrode 231 in Example 1. Although the contact area and thickness of the electrode 335 are different depending on the material used, as long as a charge which flows through the polarizing electrode can be collected, the total contact area of the electrode 335 may be equivalent to a part of the side surface of the facing polarizing electrode 110 via the separator 120. In addition, in the case where the electrode 335 is deposited on the polarizing electrode 110, it is possible to use a physical deposition method such as a sputtering method, heat resistance coating method or electron beam deposition, or a CVD method. The electrode 335 may be arranged symmetrically or non-symmetrically to each external side surface of the two polarizing electrode 110 sandwiched by the separator 120.

A conventional electric double-layer capacitor is arranged with a current collector on the entire side surface of an electrode arranged facing each other via a separator. However, as long as a charge flowing through the polarizing electrode 110 can be collected, the electrode 335 in Example 2 can be arranged separately as small spots on the side surface of the polarizing electrode 110 and therefore the total area is much smaller compared to a current collector. Therefore, by using the electrode 335 in the electric double-layer capacitor 300 related to the present invention in Example 2, it is possible to realize a lighter and thinner electric double-layer capacitor than a conventional electric double-layer capacitor.

A current collector uniforms the potential within an electrode and the distribution of a potential within an electrode is made to exist only in the thickness direction of the electrode. However, by combining the polarizing electrode 110 which also includes the function of a current collector with the electrode 231 in the electric double-layer capacitor 300, the potential within an electrode distributes across the entire electrode. In the case where this type of electrode 335 is arranged on an AC electrode, a conventional electric double-layer capacitor can no longer operate. In the electric double-layer capacitor 300 related to the present invention in Example 2, the polarizing electrode 110 also includes the function of a current collector and by providing the polarizing electrode 110 with better electrical characteristic than an AC electrode, it is possible to use the electrode 335.

As explained above, by forming the electric double-layer capacitor related to the present example from a carbon nanotube aggregate with a high carbon purity and few metal impurities, the capacitor can operate under high voltage conditions, a chemical reaction of the electrolyte solution can be controlled to a minimum and it is possible to realize an electric double-layer capacitor with a long lifetime by forming the capacitor with a high conductivity carbon nanotube aggregate. In addition, by using a high density grown carbon nanotube aggregate having an appropriate pore size, a polarizing electrode formed by a high conductivity carbon nanotube aggregate in which ions are easily dispersed is provided and a charge flows not only in a perpendicular direction but also in a horizontal direction within the polarizing electrode 110 as shown by the arrows in FIG. 4. As a result, it is not necessary to use a current collector as in a conventional capacitor, it is sufficient that an electrode partially connected to the polarizing electrode 110 include a function for inputting and extracting a charge and it is possible to provide a lightweight and small scale electric double-layer capacitor. In addition, it is possible to operate the electric double-layer capacitor related to the present example of the present invention at a high voltage over a long lifetime and provide the capacitor with a large electrical density and power density compared to a conventional electric double-layer capacitor. In this way, the electric double-layer capacitor related to the present embodiment can be driven by a driving voltage of 3.5V or less or less than 4.5V as is shown in the example. Furthermore, the voltage application components explained in Example 1 and Example 2 may be used in combination. That is, a combination is possible whereby the electrode 231 in Example 1 is used in one polarizing electrode of the electric double-layer capacitor and the electrode 335 in Example 2 is used in the other polarizing electrode.

### Example 3

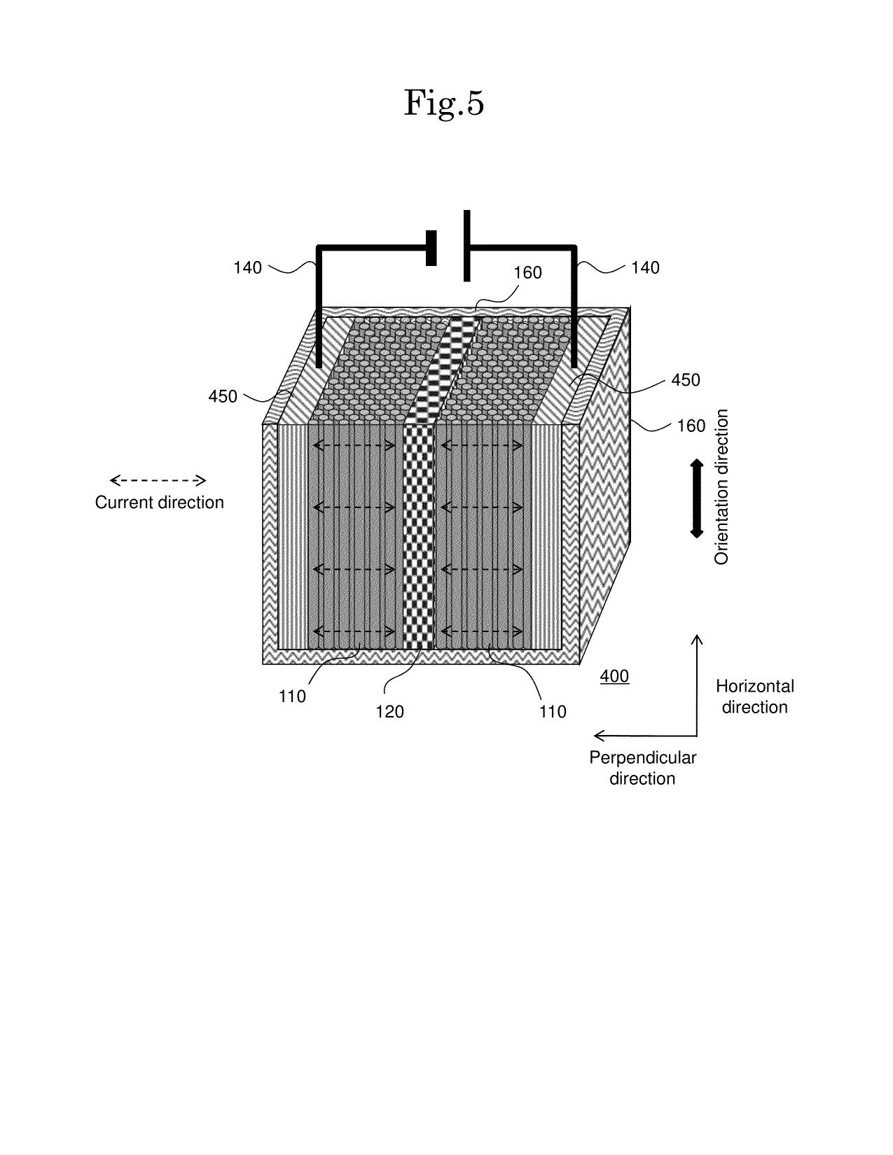

In the present example, an electric double-layer capacitor 400 applied with a conventional current collector to the polarizing electrode 110 used as the polarizing electrode related to the present invention is explained. A diagram of the electric double-layer capacitor 400 related to Example 3 of the present invention is shown in FIG. 5. in the electric double-layer capacitor 400 a separator 120 is sandwiched by two polarizing electrodes 110 (first polarizing electrode and second polarizing electrode). Two current collectors 450 are arranged to face each other on the entire external side surface of the two polarizing electrodes 110 are connected to an external electrode terminal 240. The polarizing electrode 110 is filled with an electrolyte solution. With this structure, the polarizing electrode 110, the current collectors 450 and the external electrode terminal 240 are electrically connected to each other. A barrier component 160 is arranged so as to encompass the polarizing electrode 110, separator 120 and the current collectors 450 and it is possible to seal the electrolyte solution in the polarizing electrode 110 and separator 120 using the barrier component 160. Furthermore, because FIG. 5 explains an internal structure the upper surface and front barrier component 160 are not shown.

The polarizing electrode 110, separator 120 and electrolyte solution explained in Example 1 can be used in the electric double-layer electrode 400 related to Example 3 of the present invention and details related to each one are omitted here. The electric double-layer capacitor 400 related to Example 3 has the same structure as the electric double-layer capacitor 200 apart from arranging the current collectors 450. Therefore, the same manufacturing method as the electric double-layer capacitor 200 is used up to the assembly process whereby a 40 μm thick cellulose porous paper used as the separator 120 is sandwiched in between two 9 mm×9 mm×0.75 mm semi-high density grown single-walled CNT orientated sheets 35 so that they face each other.

The two current collectors are arranged on the external side surface of the two single CNT oriented sheets 35 which sandwich the separator 120. It is possible to use a metal component such as aluminum or platinum having a direct current electrical conductivity of 1,000 S/cm or more or a sheet resistance of 0.01 ohm/square or less. The shape of the current collectors 450 may be a thin film or mesh shaped and although the thickness is different depending on the material used the collectors are formed on the entire side surface of the polarizing electrode 110.

The polarizing electrode 110 is formed by high density growing the electric double-layer capacitor 400 assembled in this way using a 1M tetraethylammonium tetrafluoroborate propylene carbonate solution the same as in Example 1.

The characteristics of the high density grown carbon nanotube aggregate which forms the polarizing electrode 110 can be evaluated by measuring the characteristics of the carbon nanotube aggregate which is high density grown using only a solvent (propylene carbonate solution). The carbon nanotube aggregate which is high density grown used in the present example had a conductivity of 20 S/cm, single-walled CNT content rate of 99.9%, a density of 0.5 g/cm³, a G/D ratio of 2.5-40, a BET-relative surface area of 1,100 m²/g, an average external diameter of 2.8 nm, a half value width of 2 nm, a carbon purity of 99.9 mass %, metal impurities of 0.013 mass %, pore size distribution maximum of 4 nm and Herman orientation factor of 0.7. The polarizing electrode 110 obtained in this way had a conductivity of 7 S/cm and was 300 S/cm after being polarized. The content amount of metal impurities was 0.008 mass % and the weight density was 0.93 g/cm³.

Because the electric double-layer capacitor 400 uses a conventional current collector 450, the electric double-layer capacitor 400 is not as light or small as the electric double-layer capacitor explained in Example 1 and Example 2. However, by arranging the current collector 450 on the entire side surface of the polarizing electrode 110 in the electric double-layer capacitor 400 related to the present example, the current collector makes the potential within the polarizing electrode 110 uniform and the distribution of the potential within the polarizing electrode 110 is made to exist only in the thickness direction of the electrode. As a result, a charge flows only in a perpendicular direction within the polarizing electrode 110 and therefore the current collection efficiency of the electric double-layer capacitor 400 is high compared to the electric double-layer capacitor related to Example 1 and Example 2 which uses a voltage application component. Consequently, it is possible to favorably use the electric double-layer capacitor 400 as a large capacity capacitor which operates at a high voltage and degradation is small even if the capacitor is larger than the electric double-layer capacitor 400 which uses an electrode.

In addition, in the case where a mesh shaped electrode is used on the side surface of the polarizing electrode 110 instead of a thin film current collector 450, it is possible to form a lighter capacitor than an electric double-layer capacitor formed with the current collector 450. In the present example platinum mesh is used as the current collector 450.

As explained above, by forming the electric double-layer capacitor related to the present example from a carbon nanotube aggregate with a high carbon purity and few metal impurities, the capacitor can operate under high voltage conditions, a chemical reaction of the electrolyte solution can be controlled to a minimum and it is possible to realize an electric double-layer capacitor with a long lifetime by forming the capacitor with a high conductivity carbon nanotube aggregate. In addition, by using a high density grown carbon nanotube aggregate having an appropriate pore size, an electric double-layer capacitor having high power in which ions are easily dispersed is realized. By combining the polarizing electrode formed using a high conductivity carbon nanotube aggregate with a highly efficient current collector it is possible to provide a large capacity electric double-layer capacitor. In addition, it is possible to operate the electric double-layer capacitor related to the present example of the present invention at a high voltage over a long lifetime and provide the capacitor with a large electrical density and power density compared to a conventional electric double-layer capacitor. In this way, the electric double-layer capacitor related to the present example can be driven by a driving voltage of 3.5V or less or less than 4.5V as is shown in the example. As described above, by using a carbon nanotube aggregate having high conductivity, the polarizing electrode also functions as a current collector and a charge flows not only in a perpendicular direction but also in a horizontal direction within the polarizing electrode 110. As a result, it is not necessary to use a current collector as in a conventional capacitor, it is possible to use a mesh shaped electrode having a function for inputting and extracting a charge and it is possible to provide a lighter electric double-layer capacitor than the case when a current collector is used.

### Example 4

An electric double layer capacitor is formed with a structure in which a plurality of capacitors is stacked in order to increase an output voltage. As a result, although an electrical contact (ohmic contact) is required between adjacent capacitors, it is necessary to prevent an ion contact (flow of an electrolyte solution) between adjacent capacitors. Since the conductivity in a conventional AC electrode is low, the entire side surface of an electrode is covered by a metal layer (usually aluminum) current collector, and this current collector plays the role of preventing ion contact between adjacent capacitors. In the present example, a method of stacking electric double-layer capacitors which does not include the current collector explained in the embodiments for increasing an output voltage is explained.

A current collector is a bipolar plate and when this type of current collector is added, the weight off the entire electric double-layer capacitor increases. In addition, demand for sealing properties and corrosion resistance of the current collector makes the structure of the electric double-layer capacitor complex. Furthermore, because the current collector is a metal, thermal conductivity is high and damage to the entire stacked electric double-layer capacitor is affected when heat is emitted when a single capacitor breaks.

In the present example, an electric double-layer capacitor 500 is shown which electrically connects adjacent polarizing electrodes 110 via a barrier component and does not require a bipolar current collector. It is possible to use the polarizing electrode 110, separator 120 and electrolyte solution explained in Example 1 in the electric double-layer capacitor 500 and the details of each of these are omitted here.

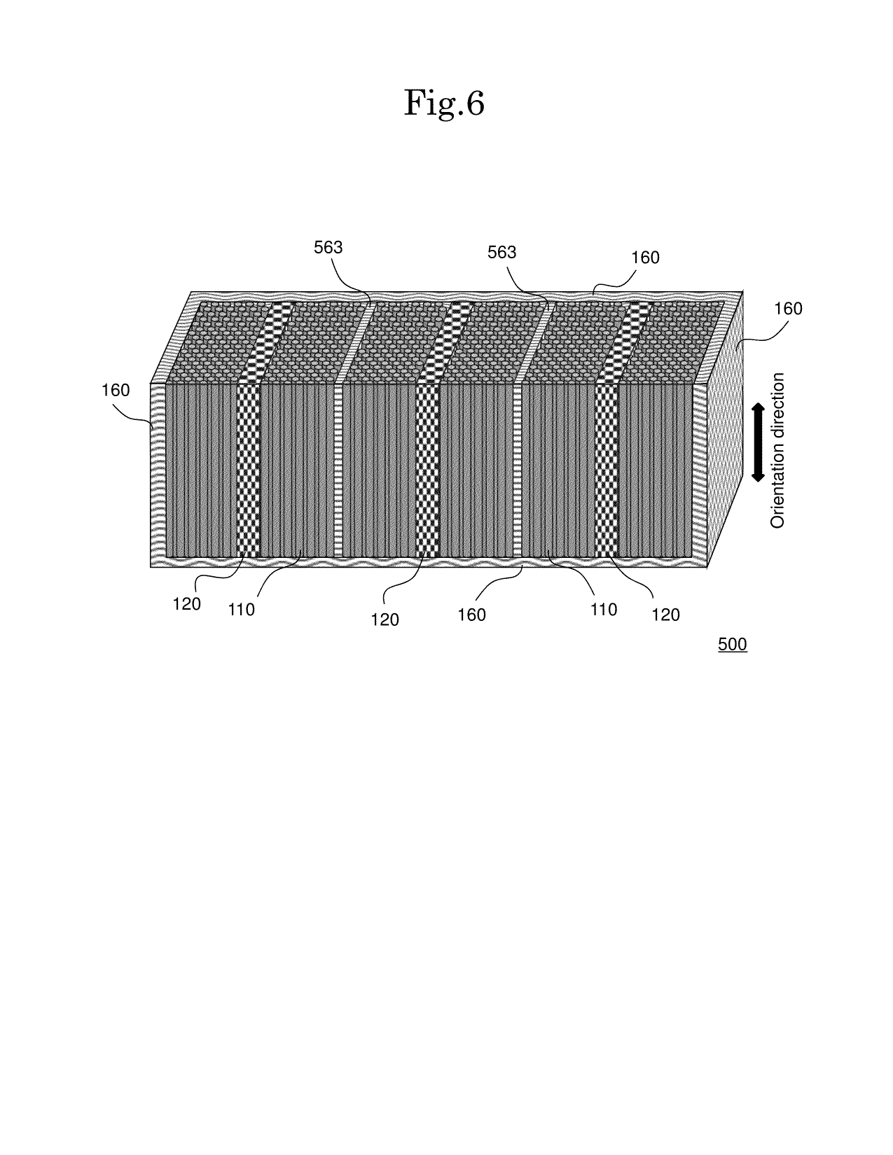

FIG. 6 shows a diagram of the electric double-layer capacitor 500. In the electric double-layer capacitor 500, electric double-layer capacitors arranged with a separator 120 between two polarizing electrodes 110 to face each other are stacked via a barrier component 563. A barrier component 160 is arranged to cover the polarizing electrodes 110, separator 120 and barrier component 563 and it is possible to seal an electrolyte solution in the polarizing electrodes 110 and separator 120 using the barrier component 160. Furthermore, because FIG. 6 explains an internal structure the upper surface and front barrier component 160 are not shown. It is possible to use a conductive polymer film such as poly 3-methyl thiophene or a flexible plastic conductor thin film such as CNT rubber for example as the barrier component 563. The barrier component 563 includes sealing properties but does not include oxygen or oxides, however the barrier component is not limited to these materials as long as the barrier component includes a direct current electrical conductivity of 100 S/cm or more and is electrochemically stable. By using the barrier component 563 which conductivity in the electric double-layer capacitor 500 it is possible to electrically connect adjacent polarizing electrode 110. In addition, although the barrier component 563 related to the present example does not have a high direct current electrical conductivity compared to a current collector, operation is possible by using a polarizing electrode 110 with excellent conductivity

As explained above, because the polarizing electrode 110 does not require a bipolar current collector, it is possible to form a stacked electric double-layer capacitor 500 even when barrier component 563 with low conductivity is used. Because metal is not used in the barrier component 563 it is very flexible and therefore the electric double-layer capacitor 500 related to the present example which uses the barrier component 563 also includes flexibility compared to a conventional stacked electric double-layer capacitor and there are no restrictions to the shape of the electric double-layer capacitor as a product.

As explained above, by forming the electric double-layer capacitor related to the present example from a carbon nanotube aggregate with a high carbon purity and few metal impurities, the capacitor can operate under high voltage conditions, a chemical reaction of the electrolyte solution can be controlled to a minimum and it is possible to realize an electric double-layer capacitor with a long lifetime by forming the capacitor with a high conductivity carbon nanotube aggregate. In addition, it is possible to operate the electric double-layer capacitor related to the present example of the present invention at a high voltage over a long lifetime and provide the capacitor with a large electrical density and power density compared to a conventional electric double-layer capacitor. In this way, the electric double-layer capacitor related to the present example can be driven by a driving voltage of 3.5V or less or less than 4.5V as is shown in the example. By using a high density drown carbon nanotube aggregate having an appropriate pore size, a polarizing electrode is provided which is formed using the high conductivity carbon nanotube aggregate in which ions are easily dispersed and thereby a current collector and a charge flows not only in a perpendicular direction but also in a horizontal direction within the polarizing electrode. As a result, it is not necessary to use a current collector as in a conventional capacitor, and it is possible to stack electric double-layer capacitors by combining conductive barrier components having a function for inputting and extracting a charge and thereby a lighter and more flexible electric double-layer capacitor than a conventional capacitor is provided. In addition, since a seal layer has a lower thermal conductivity compared to metal, heat transfer between adjacent electric double-layer capacitors is limited and it is possible to minimize the effects on adjacent electric double-layer capacitors even when one electric double-layer capacitor breaks.

### Example 5

In Example 4, an electric double-layer capacitor which seals adjacent polarizing electrodes 110 via a barrier component was explained. However, in the present example, an electric double-layer capacitor which uses a conventional current collector on the polarizing electrode 110 related to the present invention is explained. It is possible to use the polarizing electrode 110, separator 120 and electrolyte solution explained in Example 1 in an electric double-layer capacitor 600 related to Example 5 of the present invention and therefore details of each are omitted here.

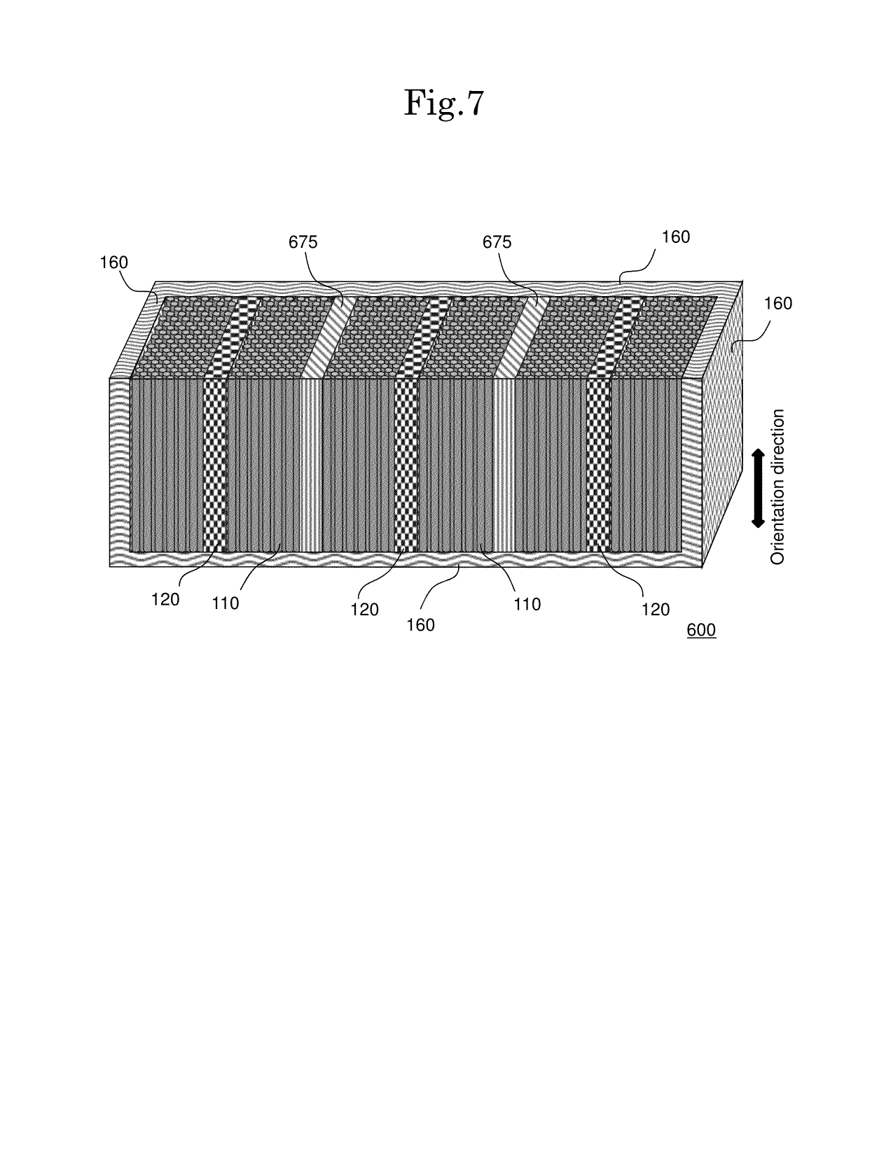

FIG. 7 shows a diagram of the electric double-layer capacitor 600. In the electric double-layer capacitor 600, electric double-layer capacitors arranged with a separator 120 between two polarizing electrodes 110 to face each other are stacked via a current collector 675. A barrier component 160 is arranged to cover the polarizing electrodes 110, separator 120 and current collector 675 and it is possible to seal an electrolyte solution in the polarizing electrodes 110 and separator 120 using the barrier component 160. Furthermore, because FIG. 7 explains an internal structure the upper surface and front barrier component 160 are not shown. It is possible to use a metal component such as aluminum or platinum having a direct current electrical conductivity of 10,000 S/cm or more or a sheet resistance of 0.01 ohm/square or less for the current collector 675 the same as the current collector explained in Example 3. Because the current collector 675 demands seals properties a mesh shaped component cannot be used. By using the current collector 675 in the electric double-layer capacitor 600, sealing properties continue to be secure and it is possible to electrically connect adjacent polarizing electrodes 110. In addition, although the electric double-layer capacitor 600 is not as flexible as the electric double-layer capacitor in Example 4 which uses a barrier component, by using the current collector 675 in the electric double-layer capacitor 600, it is possible to provide a large capacity electric double-layer capacitor by combining a polarizing electrode with excellent conductivity with a current collector with high current collection efficiency.

By forming the electric double-layer capacitor related to the present example from a carbon nanotube aggregate with a high carbon purity and few metal impurities, the capacitor can operate under high voltage conditions, a chemical reaction of the electrolyte solution can be controlled to a minimum and it is possible to realize an electric double-layer capacitor with a long lifetime by forming the capacitor with a high conductivity carbon nanotube aggregate. In addition, by using a high density grown carbon nanotube aggregate having an appropriate pore size, an electric double-layer capacitor with high power in which ions are easily dispersed is provided. In this way, the electric double-layer capacitor related to the present embodiment can be driven by a driving voltage of 3.5V or less or less than 4.5V as is shown in the example. By combining the polarizing electrode formed using a high conductivity carbon nanotube aggregate with a highly efficient current collector it is possible to provide a stacked large capacity electric double-layer capacitor. In addition, it is possible to operate the electric double-layer capacitor related to the present example of the present invention at a high voltage over a long lifetime and provide the capacitor with a large electrical density and power density compared to a conventional electric double-layer capacitor.

As explained above, by forming the electric double-layer capacitor related to Examples 1 to 5 of the present invention from a carbon nanotube aggregate with a high carbon purity and few metal impurities, the capacitor can operate under high voltage conditions, a chemical reaction of the electrolyte solution can be controlled to a minimum and it is possible to realize an electric double-layer capacitor with a long lifetime by forming the capacitor with a high conductivity carbon nanotube aggregate. In addition, by using a high density grown carbon nanotube aggregate having an appropriate pore size, an electric double-layer capacitor with high power in which ions are easily dispersed is realized. Furthermore, by using a high conductivity carbon nanotube aggregate, the polarizing electrode also functions as a current collector, it is possible to provide the electric double-layer capacitor with a structure which does not use a current collector and a lightweight and small scale electric double-layer capacitor can be provided.

### Comparative Example 1

### Manufacturing Method of an Electric Double-Layer Capacitor Using a Conventional AC Electrode

An electric double-layer capacitor using a conventional AC electrode was manufactured as Comparative Example 1. The electric double-layer capacitor 700 (not shown in the diagram) in Comparative Example 1 has the same structure as the electric double-layer capacitor 400 in Example 3 apart from using an AC electrode 710 instead of the polarizing electrode 110. FIG. 16 (a) is a diagram which shows a manufacturing process of the AC electrode 710 and FIG. 16 (b) is a SEM image of the AC electrode 710.

AC powder (below referred to as AC) (Manufactured by KURARAY CHEMICAL CO., LTD., YP17, relative surface area 1,640 m²/g) which is a known material, carbon black as a conduction aid agent and polytetrafluoroethylene (PTFE) as a binder are used to manufacture the AC electrode 710. 80% by mass of AC, 10% by mass of carbon black and 10% by mass of PTFE were pulverized and mixed together and an AC mixed compound was obtained. Next, the AC mixed compound was flattened using a roller, pressurized and heat molded and the AC electrode 710 was formed. The AC electrode 710 after vacuum drying the same as in Example 6 had a density of 0.6 g/cc, a relative surface area of 1,400 m²/g, conductivity of 0.3 S/cm, carbon purity of 99% or more, metal impurities of 1% or less, pore size distribution maximum of 1 nm or more and 2 nm or less and a size of 9 mm×9 mm×0.075 mm and the electric double-layer capacitor 700 of Comparative Example 1 was manufactured using two of these AC electrode 710 and by combining the separator 120 and current collector 450.

### Comparative Example 2

### (Manufacturing Method of an Electric Double-Layer Capacitor Using a Conventional AC Electrode Which Does Not Include a Current Collector

An electric double-layer capacitor 800 was manufactured as Comparative Example 2 with the same structure as the electric double-layer capacitor 200 in Example 1 using the AC electrode 710 explained in Comparative Example 1. That is, the electric double-layer capacitor 800 of Comparative Example 2 is different to Comparative Example 1 in that the electrode 231 is used instead of the current collector 450.

### Characteristics of a Single-Walled CNT Electric Double-Layer Capacitor

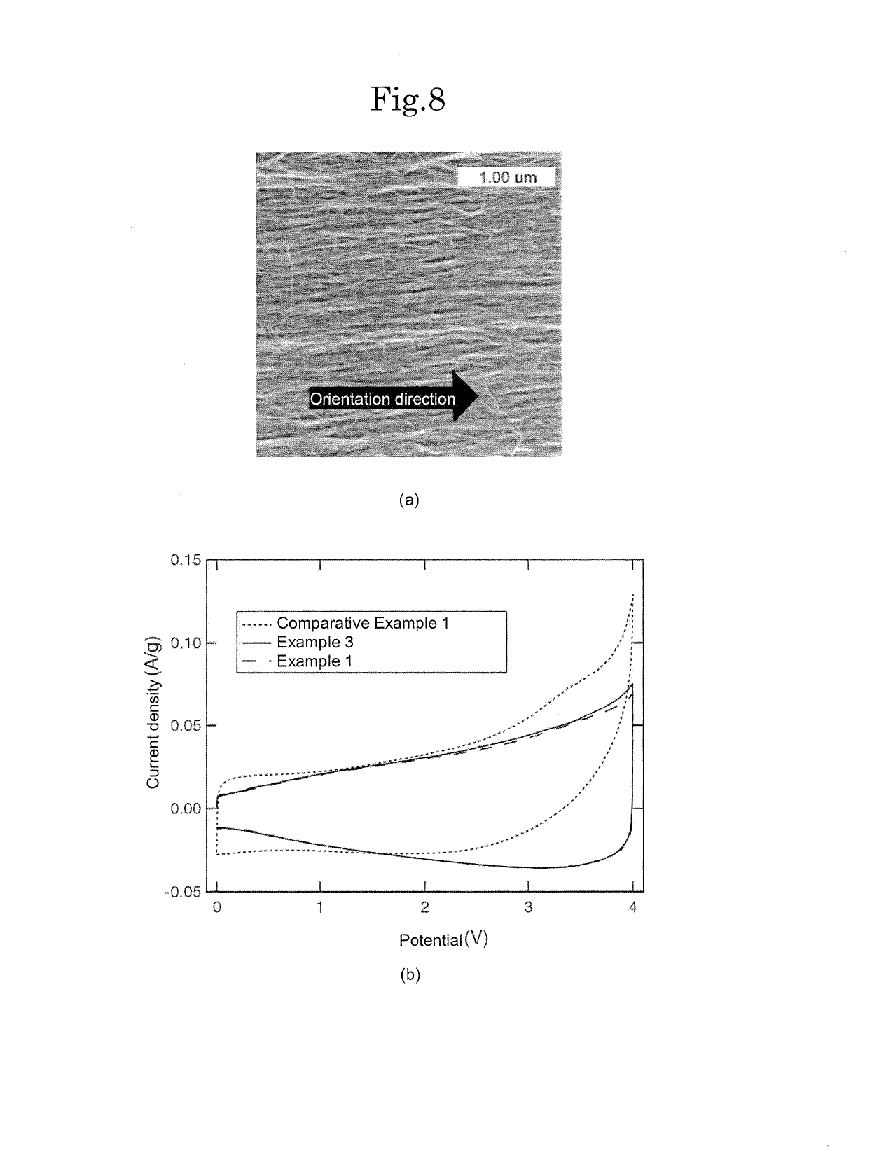

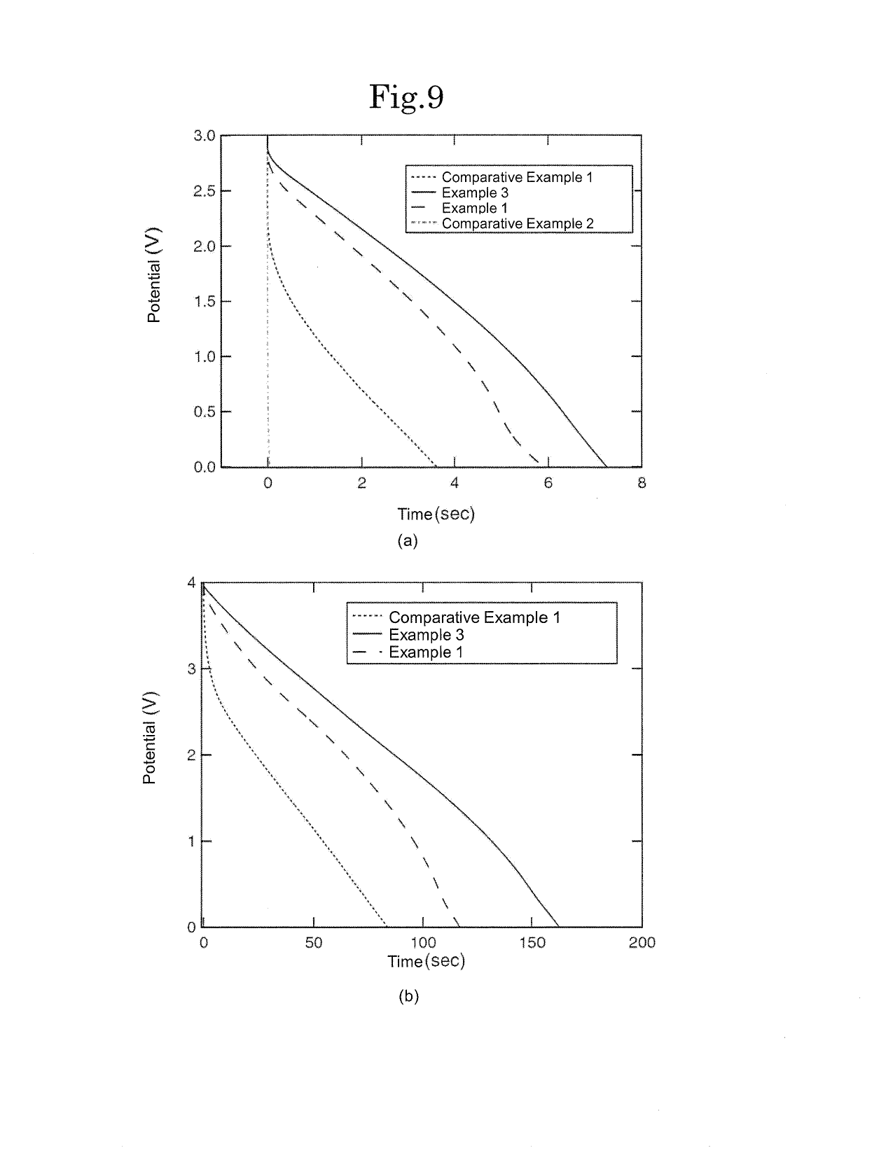

Each of the characteristics of the electric double-layer capacitor manufactured in Example 1, Example 3, Comparative Example 1 and Comparative Example 2 as described above were evaluated. FIG. 8 (a) is a SEM image observed from the side surface of the polarizing electrode 110 used in Example 1 and Example 3. The polarizing electrode 110 is formed from a carbon nanotube aggregate having excellent orientation properties. However, as is shown in FIG. 16 (b) the AC electrode 710 is formed by irregularly arranging AC and carbon black.

### Comparison of the Examples and Comparative Examples

FIG. 8 (b) is a cyclic voltammogram (below referred to as CV plot) of Example 1, Example 3 and Comparative Example 1 when polarized at 0-4V with potential shown on the horizontal axis and a current density shown on the vertical axis. The electric double-layer capacitor 200 of Example 1 and the electric double-layer capacitor 400 of Example 3 show a symmetrical plot and it can be seen that a polarizing electrode is stable over the entire range of a polarized potential. However, the electric double-layer capacitor 700 of Comparative Example 1 shows a non-symmetrical plot having a peak of 3V of more and it can be seen that at 3V or more the AC electrode breaks. In addition, although not shown in the diagram the electric double-layer capacitor 200 of Example 1 and the electric double-layer capacitor 400 of Example 3 break at a voltage of 4.5V or more.

Next, a charging and discharging test was performed to confirm the capacity and initial resistance of the electrode. FIG. 9 (a) shows a constant current discharge profile of 3V at 1 A/g and FIG. 9 (b) shows a constant current discharge profile of 4V. As is shown in FIG. 9 (a), the electric double-layer capacitor 800 of Example 2 did not operate because there was no current collector 450. In addition, as is shown in FIG. 9 (b), even at a discharge profile of 4V, the electric double-layer capacitor 200 of Example 1 and the electric double-layer capacitor 400 of Example 3 showed a good discharge profile compared to the electric double-layer capacitor 700 of Comparative Example 1.

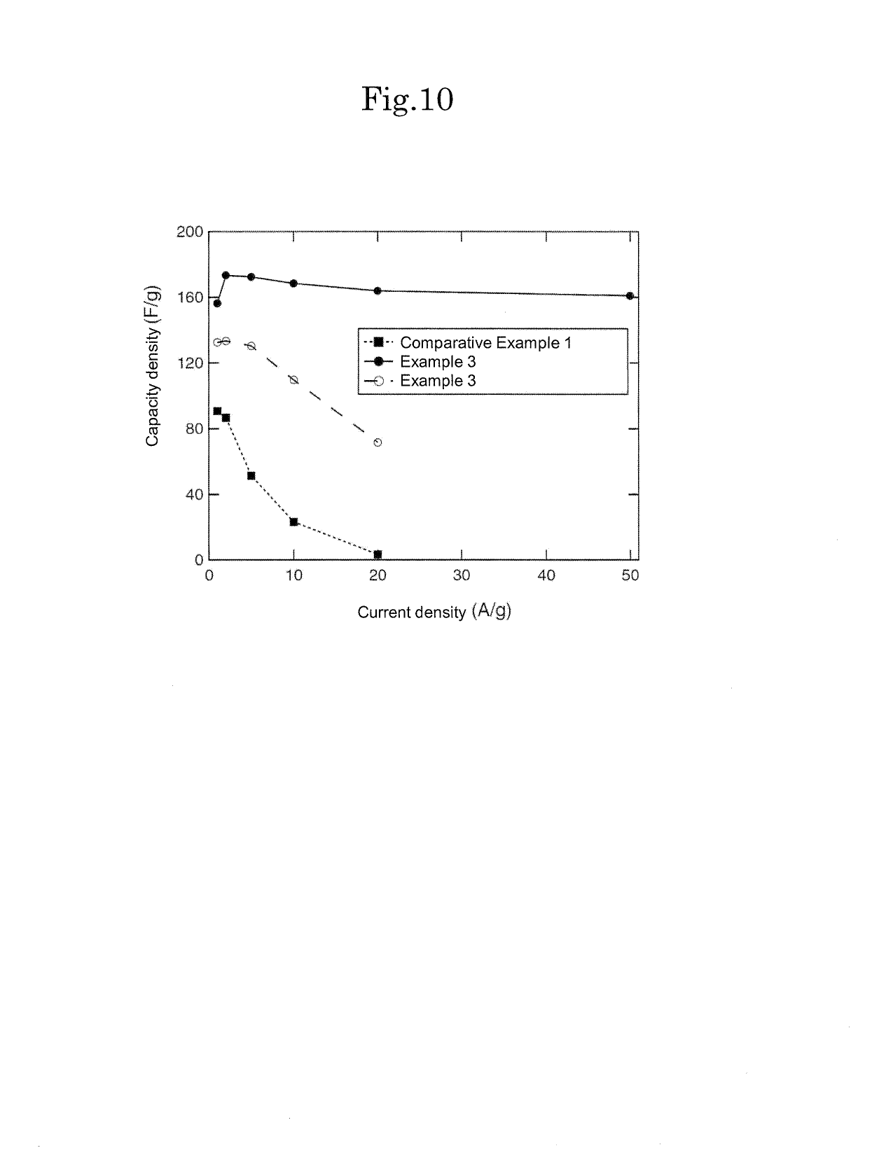

FIG. 10 shows a capacity density in a current density range of 1 A/g-50 A/g. Furthermore, the total weight of two electrodes is normalized. As can be seen from FIG. 10, the capacity density of the polarizing electrode of the electric double-layer capacitor 400 in Example 3 was 160 F/g and hardly changed even when the amount of discharge increased. However, the capacity density of the AC electrode of the electric double-layer capacitor 700 in Comparative Example 1 was about 100 F/g, decayed with an increase in the amount of discharge and did not operate when 20 F/g was exceeded. The initial value of the capacity density of the polarizing electrode of the electric double-layer capacitor 200 in Example 1 was 130 F/g which was better than Comparative Example 1. However, this decayed to half the initial value as far as 20 F/g.

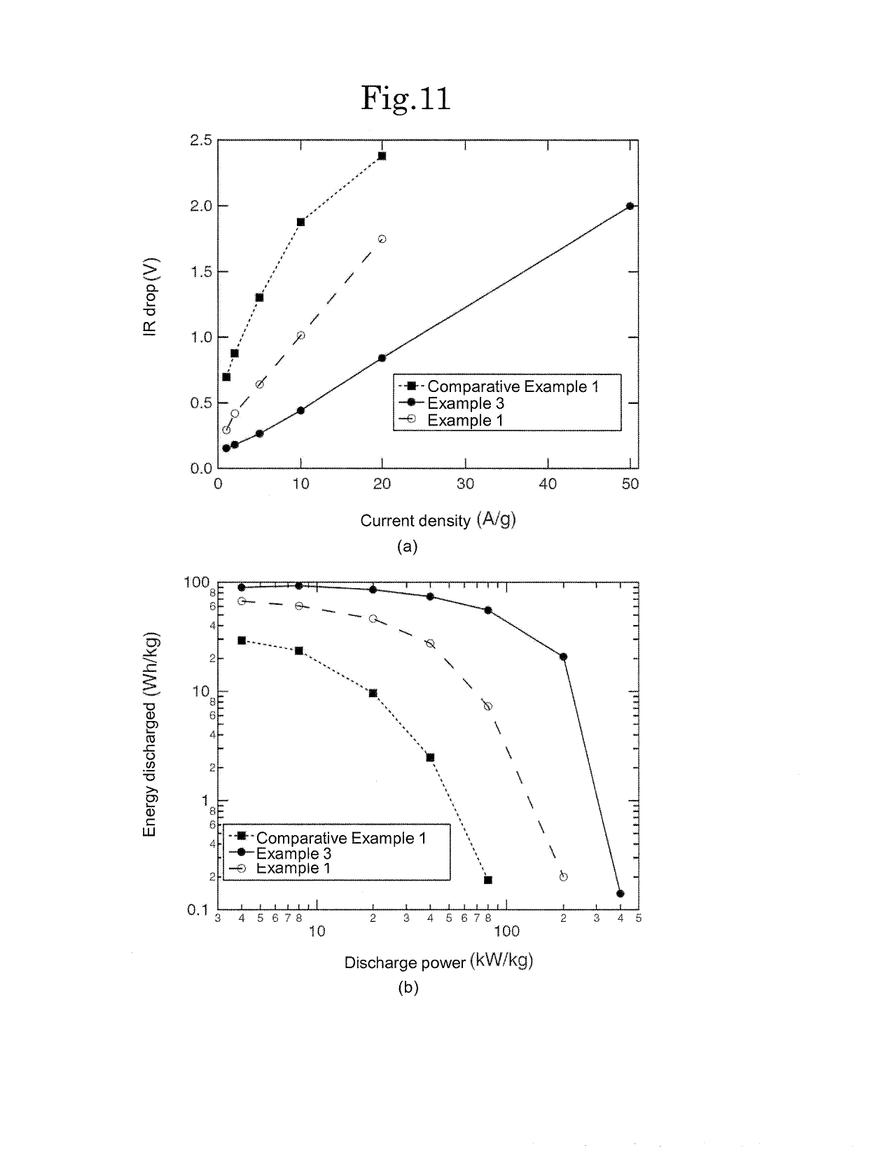

FIG. 11 (a) shows an internal resistance of an electric double-layer capacitor as an initial voltage drop (below referred to as IR drop) when discharge begins. In the electric double-layer capacitor 400 in Example 3, because the IR drop and current density show a linear relationship, it can be seen that ion transport is rapid in the polarizing electrode and there is no limit to dispersion. However, because a non-linear shaped IR drop is shown in the electric double-layer capacitor 700 in Comparative Example 1, it can be seen that dispersion is limited in the transport of AC electrode ions. Although the polarizing electrode of the electric double-layer capacitor 200 in Example 1 has a larger internal resistance compared to Example 3, the internal resistance is smaller than in Comparative Example 1. Here, as a result of accommodating an IR drop, the maximum discharge power in the electric double-layer capacitor 400 in Example 3 was 210 kW/kg and 60 W/g in the electric double-layer capacitor 700 in Comparative Example 1 (normalized by the weight of two electrodes).

Here, capacity density and IR drop were calculated by applying a simple serial RC curve model (formula 3) to a constant current discharge profile.

$$\begin{matrix}[ Formula 3 ] & \\ V ( t ) = {V}_{Charged} - 2 {IR}_{S} - \frac{It}{C} & ( 3 )\end{matrix}$$

V_{charge} shows a voltage of a discharged electric double-layer capacitor, 2/Rs shows an initial voltage drop an electrostatic capacitance was determined from the slop of the discharge curve.

FIG. 11 (b) shows energy discharged from an electrode at various discharge powers. It can be seen that the energy discharged was larger (larger than 50 kW/kg which is the limit of energy discharged in an AC electrode) at all the discharge powers from the electric double-layer capacitor 400 in Example 3 and was excellent in both energy discharged and discharge power. In addition, a larger energy was emitted from the electric double-layer capacitor 200 in Example 1 than the electric double-layer capacitor 700 in Comparative Example 1.

Here, the value of energy discharged was calculated by integrating the discharge curve as is shown in formula (4).

[Formula 4]

E=∫IV(t)dt (4)

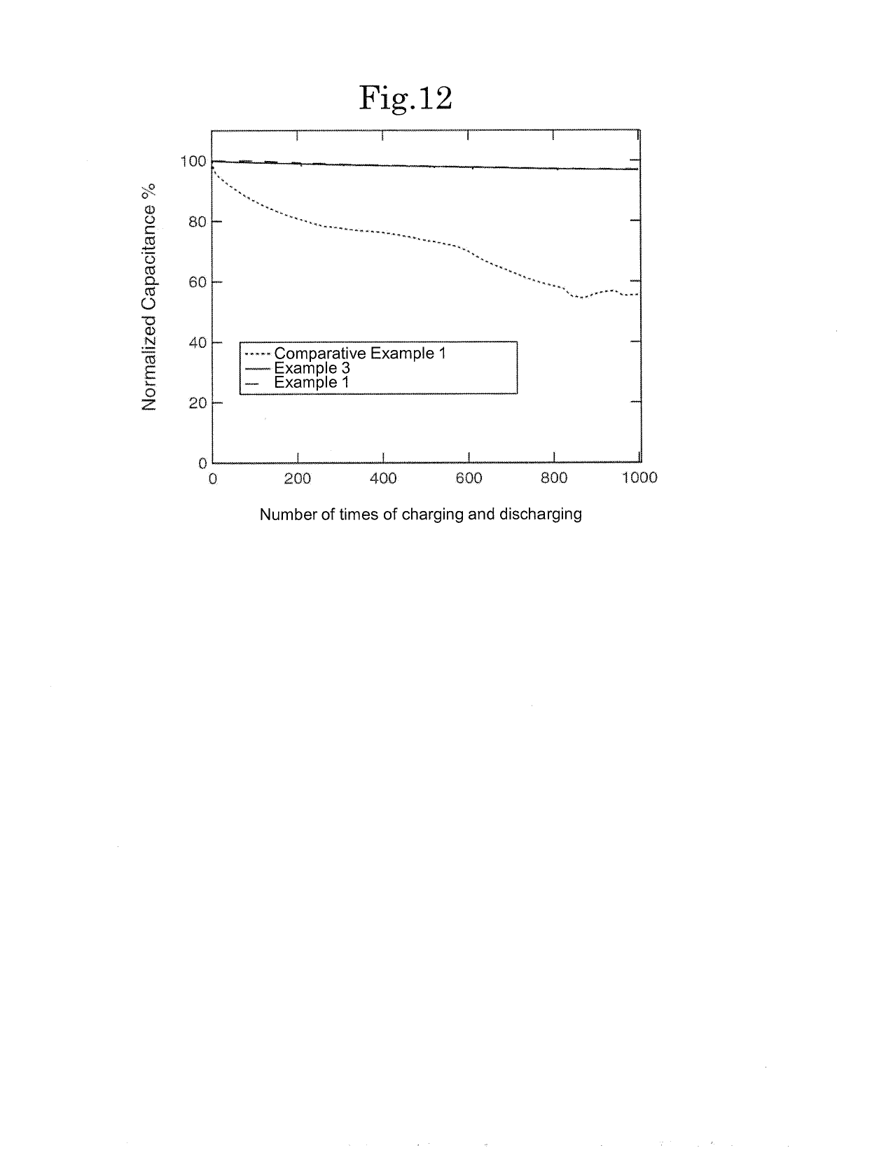

FIG. 12 shows the result of a stability test of an electrode when charging and discharging 1,000 times when current density is 1 A/g, in a potential range of 0V-4V. In the electric double-layer capacitor 400 in Example 3, there was a slight decrease in capacity density of less than 3%, however, a significant decay of 46% was shown in the electric double-layer capacitor 700 in Comparative Example 1 despite performing the test over a small potential range of 0V-3.5V. In addition, the electric double-layer capacitor 200 in Example 1 also showed a result which compared favorably with the electric double-layer capacitor 400 in Example 3.

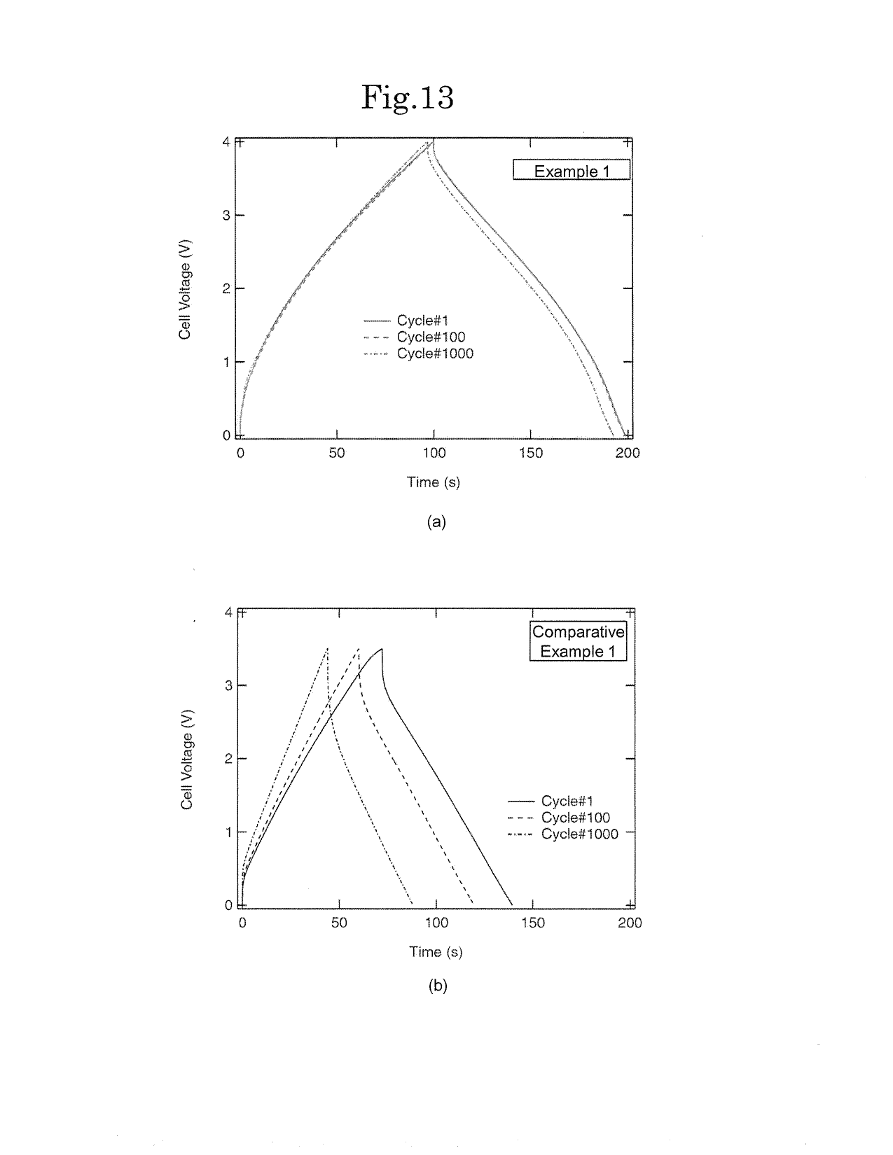

FIG. 13 is a diagram showing a 1, 100, 1,000^{th} charging and discharging cycle of a durability test, FIG. 13 (a) shows the result of the electric double-layer capacitor 200 in Example 1 and (b) shows the result of the electric double-layer capacitor 700 in Comparative Example 1. The electric double-layer capacitor 200 in Example 1 stopped at a decay rate of 3.6% at the 1,000^{th} cycle. However, the electric double-layer capacitor 700 in Comparative Example 1 decayed by 46% at the 1,000^{th} cycle.

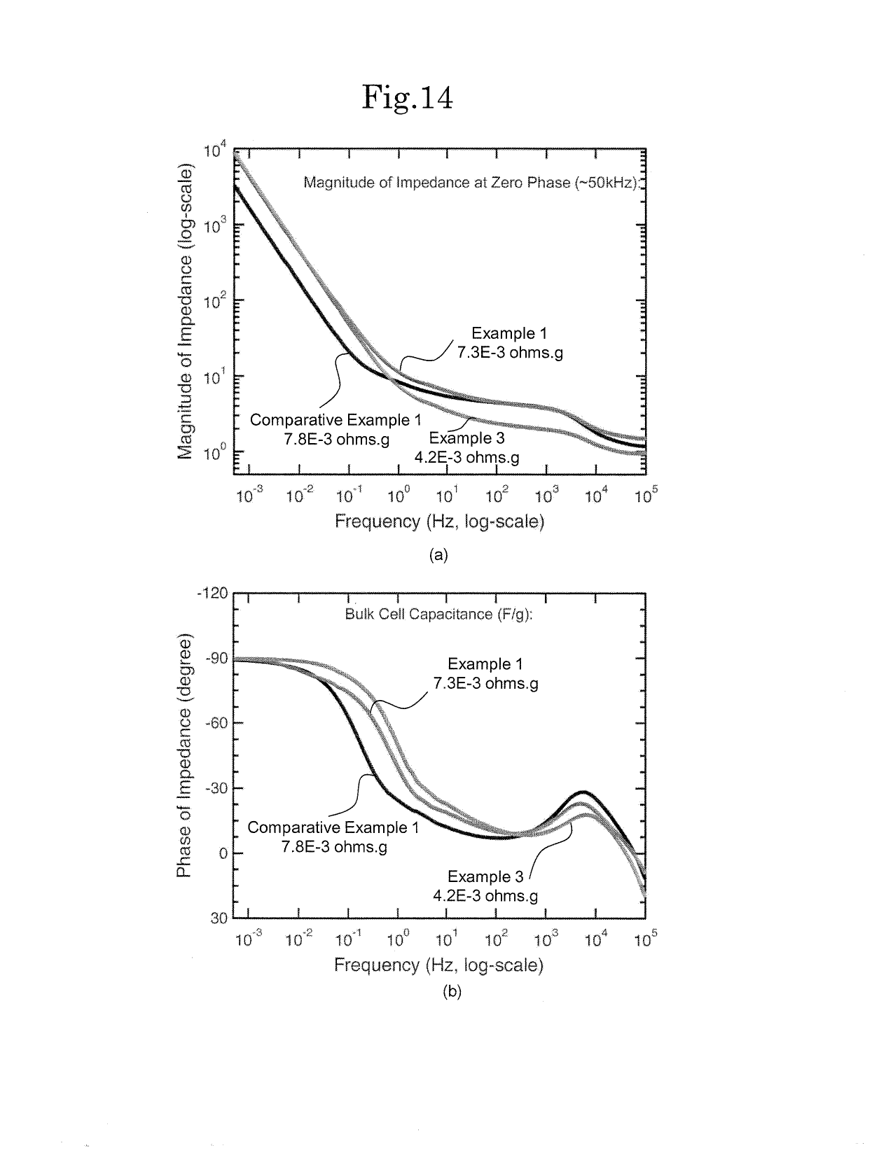

FIG. 14 shows an impedance bode plot, (a) shows the amplitude and (b) shows the phase of the impedance. The electric double-layer capacitor 400 in Example 3 has the smallest internal resistance. The internal resistance of the electric double-layer capacitor 200 in Example 1 increased but was small compared to the electric double-layer capacitor 700 in Comparative Example 1. The value of an electrostatic capacitance estimated from an impedance spectrum of a low frequency region was low as a device which is not charged (0V direct current bias). Here, a value was normalized by the dry weight of a working electrode and opposite electrode.

The charging and discharging effects of an electric double-layer capacitor, for example are largely related to an internal resistance such as IR loss. As a result, the charging and discharging effects depend on the test conditions used. The charging and discharging effects are the difference between an energy (E-charged) used during the charging period and an energy (E-discharged) recovered during a discharging period estimated from the E-charged. Here, the charging and discharging effects at 1 A/g were as follows: the electric double-layer capacitor 400 in Example 3 (charged from 0V to 4V and discharged during 0V) was 89%, the electric double-layer capacitor 200 in Example 1 (charged from 0V to 4V and discharged during 0V) was 83% and the electric double-layer capacitor 700 in Comparative Example 1 (charged from 0V to 3.5V and discharged during 0V) was 67%.

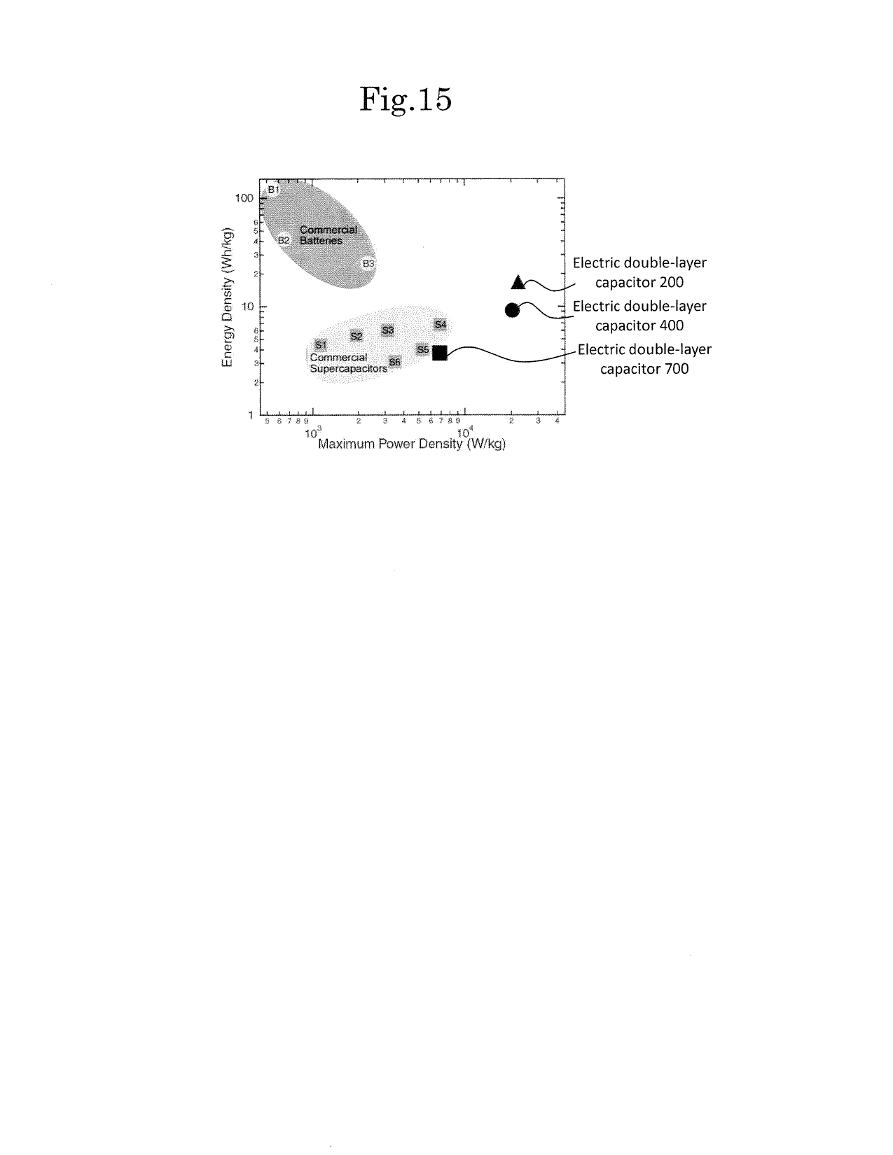

FIG. 15 is a diagram showing a performance prediction of a packaged electric double-layer capacitor. Although the electric double-layer capacitor 200 arranged with the polarizing electrode shown in Example 1 is not packaged, the performance of the electric double-layer capacitor 200 in Example 1 described above and the performance of a conventional commercially available electric double-layer capacitor were compared. The electric double-layer capacitor 200 had an energy density (17 Wh/kg) about the same as a lead-acid battery and the maximum power density was predicted to be 100 times (24 kW/kg).

Here, maximum power density was calculated using an R_{S} value calculated from a linear adaptive of the IR_{drop} value shown in formula (5).

[Formula 5]

IR_{drop}=a+b*I (5)

a shows a potential difference of an electric double-layer capacitor charge and discharge with 4V, b shows an internal resistance (R_{S}), and I shows a discharged current.

$$\begin{matrix}[ Formula 6 ] & \\ {P}_{MAX} = \frac{{V}_{OCV}^{2}}{4 {R}_{S}} = \frac{{( 4 - a )}^{2}}{2 b} & ( 6 )\end{matrix}$$

As explained above, the electric double-layer capacitor arranged with a polarizing electrode related to the present embodiment is driven at a high driving voltage of 3.5V or more and less than 4.5V, and it is possible to provide an electric double-layer capacitor with a long lifetime with hardly any degradation even after performing charging and discharging over 1,000 times. In addition, in the electric double-layer capacitor arranged with a polarizing electrode related to the present invention, because it is not necessary to use a current collector as in a conventional electric double-layer capacitor since the polarizing electrode also functions as a current collector, it is possible to provide a lightweight and small scale electric double-layer capacitor.

According to the manufacturing method of the present invention, an electric double-layer capacitor is provided which has a long lifetime, operates at a high voltage and does not require a current collector arranged on the entire side surface of a polarizing electrode, and therefore can be easily reduced in size and weight.

1. An electric double-layer capacitor comprising:
a first polarizing electrode and a second polarizing electrode including a carbon nanotube aggregate formed by aggregating a plurality of carbon nanotubes and an electrolyte solution being immersed between the plurality of carbon nanotubes, the first polarizing electrode and the second polarizing electrode are provided with a conductivity of 0.5 S/cm or more;
an electrode connected to the first polarizing electrode and the second polarizing electrode; and
a separator arranged between the first polarizing electrode and the second polarizing electrodes;
wherein the carbon nanotube aggregate has a relative surface area of 800 ²/g or more and 2,600 m²/g or less, a density of 0.5 g/cm³ or more and 1.5 g/cm³ or less and a pore size distribution maximum of 1 nm or more and 10 nm or less, and a charge flows through the first polarizing electrode and/or the second polarizing electrode in a horizontal direction and a perpendicular direction towards the electrode, and
wherein the electric double-layer capacitor is driven at a high driving voltage of 3.5V or more and 4.5V or less, and possible number of times of charging and discharging is 1,000 or more.

2. The electric double-layer capacitor according to claim 1, wherein the electrode is arranged on a side surface of the first polarizing electrode and the second polarizing electrode and the electrode has a mesh shape.

3. The electric double-layer capacitor according to claim 1, wherein the electrode is arranged on a side surface of the first polarizing electrode and the second polarizing electrode and an external electrode terminal is further arranged.

4. The electric double-layer capacitor according to claim 1, wherein the electrode is arranged on an end part of the first polarizing electrode and the second polarizing electrode.

5. An electric double-layer capacitor comprising:
a first polarizing electrode and a second polarizing electrode arranged with a carbon nanotube aggregate formed by aggregating a plurality of carbon nanotubes;
a separator arranged between the first polarizing electrode and the second polarizing electrodes;
an electrode partially connected to the first polarizing electrode and/or the second polarizing electrode; and
a barrier component covering the first polarizing electrode and the second polarizing electrode;
wherein the first polarizing electrode and/or the second polarizing electrode are provided with a 1 mass % of metal impurities and the capacitor is driven with a driving voltage of 3.5V or more and 4.5V or less, and possible number of times of charging and discharging is 1,000 or more.

6. The electric double-layer capacitor according to claim 5, wherein the carbon nanotube aggregate has a relative surface area of 800 m²/g or more and 2600 m²/g or less, a density of 0.5 g/cm³ or more and 1.5 g/cm³ or less and a pore size distribution maximum of 1 nm or more and 10 nm or less.

7. The electric double-layer capacitor according to claim 5, wherein the electrode is arranged on a side surface of the first polarizing electrode and the second polarizing electrode and the electrode has a mesh shape.

8. The electric double-layer capacitor according to claim 5, wherein the electrode is arranged on a side surface of the first polarizing electrode and the second polarizing electrode and an external electrode terminal is further arranged.

9. The electric double-layer capacitor according to claim 5, wherein the electrode is arranged on an end part of the first polarizing electrode and the second polarizing electrode.
